(19) United States
(12) Patent Application Publication
(10) Pub. No.: US 2012/0162002 A1
(43) Pub. Date: Jun. 28, 2012

(54) ELECTROMAGNETIC TOMOGRAPHY APPARATUSES AND METHODS

(75) Inventor: Serguei Semenov, Staffordshire (GB)

(73) Assignee: KEELE UNIVERSITY, STAFFORDSHIRE (GB)

(21) Appl. No.: 13/393,605

(22) PCT Filed: Sep. 3, 2010
(86) PCT No.: PCT/GB10/01679

§ 371 Date: Mar. 1, 2012

(30) Foreign Application Priority Data
Sep. 4, 2009 (GB) 0915491.5

(51) Int. Cl. G01S 13/89

(52) U.S. Cl. 342/22

(57) ABSTRACT

A tomography apparatus for producing image data representative of a dielectric and/or conductivity property distribution within an object using electromagnetic radiation having a frequency in the range 0.05 GHz to 10 GHz, the apparatus having: a processing means for producing image data representative of a dielectric and/or conductivity property distribution within an object located in the imaging domain based on measurement data from the measuring means, wherein the tomography apparatus is configured so that electromagnetic radiation incident on the receivers during a second time period t₂ is disregarded for the production of said image data when the apparatus is in use, the second time period t₂ being subsequent to a first time period t₁ during which electromagnetic radiation is emitted by a selected one of the emitters. The tomography apparatus may include waveguide antennae, the real component μᵣ′ of the complex relative permeability μᵣ of each waveguide antenna being substantially more than 1.

This invention relates to tomography apparatuses and methods for producing image data representative of a dielectric and/or conductivity property distribution within an object using electromagnetic radiation having a frequency in the range 0.05 GHz to 10 GHz. Preferably, object to be imaged is biological tissue, e.g. human tissue.

In general, a tomography apparatus of this type may be described as having:

a plurality of emitters for emitting electromagnetic radiation having a frequency in the range 0.05 GHz to 10 GHz, the emitters being spatially distributed around an imaging domain;

a plurality of receivers spatially distributed around the imaging domain for receiving electromagnetic radiation;

a control means for controlling the apparatus to emit electromagnetic radiation from each of the emitters;

a measuring means for producing measurement data representative of electromagnetic radiation received by the receivers after it has interacted with an object located in the imaging domain; and

a processing means for producing image data representative of a dielectric and/or conductivity property distribution within an object located in the imaging domain based on measurement data from the measuring means.

Electromagnetic radiation having a frequency in the range 0.05 GHz to 10 GHz interacts with an object to be imaged as a function of the dielectric and conductivity properties of the object. This interaction causes a change in the amplitude, phase and polarisation of the electromagnetic radiation. Accordingly, by measuring one or more of the amplitude, phase and polarisation of the electromagnetic radiation after it has interacted with the object to be imaged, it is possible to produce image data representative of a dielectric and/or conductivity property distribution within the object, e.g. a complex permittivity distribution within the object. Complex permittivity is a well-known property that is representative of both a dielectric property (permittivity) and a conductivity property (electrical conductivity) of an object.

The frequencies of electromagnetic radiation used by the type of tomography apparatus to which this invention relates, mostly lie in the microwave region of the electromagnetic spectrum (the microwave region of the electromagnetic spectrum may be taken as covering electromagnetic radiation having a frequency between 0.3 to 300 GHz). Consequently, such tomography apparatuses are sometimes known as “microwave tomography” or “microwave tomographic imaging” apparatuses. However, as explained below in more detail, it may also be useful for such apparatuses to use electromagnetic radiation having a frequency outside the microwave region, e.g. 0.05 GHz. Therefore, although a tomography apparatus according to the invention may be referred to as a “microwave tomography” or “microwave tomographic imaging” apparatus, this invention should not be viewed as being limited to use with electromagnetic radiation having a frequency within the microwave region of the electromagnetic spectrum.

Known microwave tomography apparatuses are described, for example, in published patent application Nos. WO95/32665, WO98/01069, WO98/52464, WO2008/087451 and US2002/0065463 and in published U.S. Pat. Nos. 5,715,819, 6,026,173, 6,332,087, 6,490,471.

In known microwave tomography apparatuses, it is conventional to have an imaging chamber including one or more walls which define a boundary of the imaging domain. The imaging chamber is conventionally filled with an “interface medium”, the purpose of which is to match the dielectric properties of the emitters and receivers to the dielectric properties of the object to be imaged. This dielectric matching is achieved by adjusting the real component of the complex permittivity of the interface medium, the emitters and the receivers, to be as close to that of the object to be imaged as possible. In this way, the proportion of electromagnetic radiation which is reflected at boundaries between the emitters, the interface medium, the object to be imaged and the receivers is reduced, and therefore the proportion of electromagnetic radiation which passes through the object to be imaged is increased.

A common type of interface medium is a “matching solution”, which is an aqueous solution having dielectric properties similar to those of the object to be imaged. The matching solution may include one or more components selected from the group consisting of: one or more salts, fatty emulsion, sugar or glycerol.

By varying the proportions of the one or more components of the matching solution, it is possible to control the matching properties and attenuation coefficient of the matching solution.

Matching solutions are typically made to have a high attenuation coefficient so as to further reduce the proportion of electromagnetic radiation which is reflected at boundaries between the emitters, the matching solution, the object to be imaged and the receivers. The attenuation coefficient of the matching solution is preferably optimised to maximise the proportion of electromagnetic radiation which passes through the object to be imaged and is received by the receivers, i.e. optimised to maximise the signal to noise ratio.

Microwave tomography apparatuses find particular applicability in biomedical applications, where the object to be imaged includes biological tissue e.g. human tissue. For example, as described in U.S. Pat. No. 7,239,731, image data representative of the complex permittivity distribution within biological tissue may be used for non-invasive detection of physiological and pathological conditions, such as tissue hypoxia, myocardial ischemia, and infarction.

The interaction of electromagnetic radiation with biological tissue can be extremely complex. Consequently, producing image data representative of a dielectric and/or conductivity property distribution within biological tissue using electromagnetic radiation having a frequency in the range 0.05 GHz to 10 GHz involves solving complex mathematical equations. Solving such equations to produce image data representative of a dielectric and/or conductivity property distribution within biological tissue has been the subject of many previous studies [Refs 6, 12 to 23].

Until now, research into microwave tomography has tended to focus on demonstrating the feasibility and practicability of the technology involved. As a result, known microwave tomography apparatuses tend to be large, unwieldly, complicated to use and therefore are only suitable for research, rather than clinical use.

In general, this invention seeks to provide tomography apparatuses and methods which address drawbacks associated with known microwave tomography apparatuses, preferably so as to provide tomography apparatuses and methods suitable for use in a clinical environment, i.e. for imaging human tissue. Preferably, this invention provides tomography apparatuses and methods which are better suited to the clinical environment, e.g. by reducing the size of the apparatus and/or by making the apparatus lower cost or easier to use.

The first aspect of the invention relates to using waveguide antennae as the emitters and/or receivers in a microwave tomography apparatus.

Most known microwave tomography apparatuses use dipole antennae as emitters and/or receivers. However, the inventor has found it advantageous to use waveguide antennae as the emitters and/or receivers in tomography apparatuses because they are able to emit electromagnetic radiation predictably and repeatably, independently of any object(s) located within the imaging domain.

Conventional waveguide antennae for emitting/receiving frequencies of electromagnetic radiation in the range 0.05 GHz to 10 GHz tend to be bigger than equivalent antennae of other types (e.g. equivalent dipole antennae). Therefore, it can be difficult to fit many waveguide antennae around an imaging domain.

To address these issues, the inventor considered reducing the size of waveguide antennae for use in a tomography apparatus. However, the inventor found that simply reducing the size of the waveguide antennae (without making any other changes) could increase the amount of computation required to calculate the electromagnetic fields between individual pairs of the waveguide antennae. This is undesirable, because it would mean that a larger amount of computation would be required to produce image data using a tomography apparatus in which the waveguide antennae were used as emitters and/or receivers.

To address these issues, the first aspect of the invention may provide a tomography apparatus according to claim 1.

By having waveguide antennae with a complex relative permeability whose real component μᵣ′ is substantially more than μᵣ the inventor has found it possible to reduce the size of the emitting and/or receiving surface of the waveguide antennae used in a tomography apparatus, without necessarily increasing the amount of computation required to produce image data. A reduction in the size of the emitting and/or receiving surface of the waveguide antennae makes it possible to fit more emitters and/or receivers around the imaging domain which can help to improve the quality of the image data produced by the tomography apparatus.

It is noted that the complex relative permittivity ∈ᵣ and the complex relative permeability μᵣ of a given material are not constant, as these properties vary with the conditions in which they are measured. Therefore, values of relative permittivity ∈ᵣ and the relative permeability μᵣ referred to herein are defined as being measured using electromagnetic radiation having a frequency of between 0.05 GHz to 10 GHz (preferably at 1 GHz) and a power density of 1 mW cm⁻², in normal atmospheric conditions. Normal atmospheric conditions may be taken as a temperature of between 20° C. and 40° C., atmospheric pressure and atmospheric humidity. These conditions correspond to the conditions in a tomography apparatus according to the invention.

For reasons explained in more detail below, for a waveguide antenna to operate in a preferred H₁₀ mode, the emitting and/or receiving surface of the waveguide antenna should have a width w greater than a minimum value wₘᵢₙ that is inversely proportional to the square root of the real component ∈ᵣ′ of the complex relative permittivity ∈ᵣ, i.e. wₘᵢₙ∝1/\sqrt{∈ᵣ′}. Therefore, the larger the real component ∈ᵣ′ of the complex relative permittivity ∈ᵣ is, the smaller it is possible to make the emitting/receiving surface of the waveguide antenna, whilst still allowing the waveguide antenna to operate in H₁₀ mode.

However, it may be advantageous for the complex relative permittivity ∈ᵣ of the waveguide antenna to be matched to that of the object to be imaged and an interface medium (if present) so that the proportion of electromagnetic radiation reflected at boundaries between the waveguide antennae, the interface medium (if present), and the object to be imaged, is reduced. In such cases, increasing the real component ∈ᵣ′ of the complex relative permittivity ∈ᵣ of the waveguide antenna above the values typical for and object to be imaged (e.g. near 30-50 for human tissue) may not be desirable as it could worsen the matching between the waveguide antenna and the object to be imaged.

For reasons explained in more detail below, the minimum value wₘᵢₙ is also inversely proportional to the square root of the real component μᵣ′ of the complex relative permeability μᵣ, i.e. wₘᵢₙ∝1/\sqrt{μᵣ′}. Therefore, the larger the real component μᵣ′ of the complex relative permeability μᵣ is, the smaller it is possible to make the emitting/receiving surface of the waveguide antenna, whilst still allowing the waveguide antenna to operate in H₁₀ mode.

Accordingly, it is preferable for the real component μᵣ′ of the complex relative permeability μᵣ of each waveguide antenna to be as large as practicable. For example, the real component μᵣ′ of the complex relative permeability μᵣ of each waveguide antenna may be 2 or more, 5 or more, 10 or more, 20 or more, 30 or more, 40 or more, or 50 or more.

Preferably, the waveguide antenna includes a substrate of dielectric material. The dielectric material is preferably ceramic. The ceramic preferably includes ferroelectric ceramic compounds such as barium titanates (e.g. BaTi₄O₉ or Ba₂Ti₉O₂₀).

Preferably, a ferrite material is dispersed within the substrate of dielectric material. In this way, the ferrite material can act to raise the real component of the relative permeability of the waveguide antenna to be substantially more than 1. Preferred ferrite materials include nanocrystalline Fe—Co—Ni—B based materials and hexa-ferrites having the formula M(Fe₁₂O₁₉), where M is usually barium, strontium, calcium or lead.

The term “ferrite material” is defined herein as a material having a complex relative permeability μᵣ whose real component μᵣ′ is greater than 1.

The algorithms typically used by computer programs to produce image data in microwave tomography apparatuses require the calculation of the electromagnetic fields within the imaging domain between individual pairs of emitters and receivers, sometimes for individual iterations within the computer program. This so-called “direct problem” of microwave tomography is one of the most computationally intensive portions of the imaging algorithms. In general, there are mathematical methods that permit the precise calculation of the electromagnetic field between any pair of waveguide antennae. However, the amount of computation necessary to produce image data using these mathematical methods can be very high if it is mathematically complex to calculate the electromagnetic fields within the imaging domain between individual pairs of waveguide antennae.

From a mathematical point of view, it is relatively simple to calculate the electromagnetic field between waveguide antennae which operate in H₁₀ mode. Therefore, it is preferable for the waveguide antennae of the tomography apparatus to be configured to operate in H₁₀ mode, in order to reduce the amount of computation required to produce image data using the tomography apparatus.

A waveguide antenna having a rectangular emitting/receiving surface operates in H₁₀ mode when the frequency f of the electromagnetic radiation emitted/received by the waveguide antenna satisfies the inequality [Ref 1]:

$$f \geq \frac{1}{2 x \sqrt{μ ɛ}} ,$$

where x is the largest width (in metres) of the emitting emitting and/or receiving surface, μ=complex permeability of the waveguide antenna, and ∈ is the complex permittivity of the waveguide antenna.

To avoid higher modes of interference, it is further preferable for the waveguide antenna to satisfy the inequality:

$$f \leq 2 * \frac{1}{2 x \sqrt{μɛ}}$$

The complex permeability μ of the waveguide antenna is given by the equation μ=μₒμᵣ, where μₒ is the permeability of free space and μᵣ is the complex relative permeability of the waveguide antenna. The complex permittivity ∈ of the waveguide antenna is given by the equation ∈=∈ₒ∈ᵣ, where ∈ₒ is the permittivity of free space and ∈ᵣ is the complex relative permittivity of the waveguide antenna. The speed of light in free space is defined by the equation c=1/\sqrt{∈ₒμₒ}=2.9979×10⁸ metres per second. Accordingly, the above inequalities can be rewritten as:

$$f \geq \frac{c}{2 x \sqrt{{μ}_{r} {ɛ}_{r}}} and$$

$$f \leq 2 * \frac{c}{2 x \sqrt{{μ}_{r} {ɛ}_{r}}}$$

The complex relative permeability of the waveguide antenna can be expressed as μᵣ=μᵣ′+jμᵣ″, where μᵣ′ is the real component and μᵣ″ is the imaginary component of the complex relative permeability. Likewise, the complex relative permittivity of the waveguide antenna can be expressed as ∈ᵣ=∈ᵣ′+j∈ᵣ″, where ∈ᵣ′ is the real component and ∈ᵣ″ is the imaginary component of the complex relative permittivity. For a waveguide antenna, the real components μᵣ′,∈ᵣ′ of the relative permeability and permittivity will typically be larger than the complex components μᵣ″,∈ᵣ″. Accordingly, the above inequalities can be rewritten as:

$$f \geq \frac{c}{2 x \sqrt{{μ}_{r}^{′} {ɛ}_{r}^{′}}} and$$

$$f \leq 2 * \frac{c}{2 x \sqrt{{μ}_{r}^{′} {ɛ}_{r}^{′}}}$$

It follows that for a waveguide antenna to operate in H₁₀ mode using electromagnetic radiation having a frequency f, the emitting and/or receiving surface of the waveguide antenna should have a width w which satisfies the inequality:

$$w \geq \frac{c}{2 f \sqrt{{μ}_{r}^{′} {ɛ}_{r}^{′}}}$$

To avoid higher modes of interference, it is further preferable for the width of the waveguide antenna to satisfy the inequality:

$$w \leq 2 * \frac{c}{2 f \sqrt{{μ}_{r}^{′} {ɛ}_{r}^{′}}}$$

Accordingly, it is preferable for each waveguide antenna to have an emitting and/or receiving surface facing the imaging domain, the emitting and/or receiving surface having a width w which satisfies the inequality:

$$w \geq \frac{c}{2 {f}_{lower} \sqrt{{μ}_{r}^{′} {ɛ}_{r}^{′}}} ,$$

where c is the speed of light in free space in metres per second, f_{lower} is an lower boundary frequency of electromagnetic radiation in Hz, μᵣ′ is the real component of the complex relative permeability of the waveguide antenna, and ∈ᵣ′ is the real component of the complex relative permittivity of the waveguide antenna.

Likewise, to avoid higher modes of interference, it is further preferable for the width of the waveguide antenna to satisfy the inequality:

$$w \leq 2 * \frac{c}{2 {f}_{lower} \sqrt{{μ}_{r}^{′} {ɛ}_{r}^{′}}} .$$

In other words, for a waveguide antenna to operate in H₁₀ mode, the emitting and/or receiving surface should have a width w greater than or equal to a minimum value wₘᵢₙ given by the equation

$${w}_{min} = \frac{c}{2 {f}_{lower} \sqrt{{μ}_{r}^{′} {ɛ}_{r}^{′}}} .$$

Hence, as referred to above, wₘᵢₙ is inversely proportional to the square root of the real component μᵣ′ of the complex permeability and to the square root of the real component ∈ᵣ′ of the complex permittivity.

Likewise, to avoid higher modes of interference, the emitting and/or receiving surface should have a width w less than or equal to a maximum value wₘₐₓ given by the equation

$${w}_{max} = 2 * \frac{c}{2 {f}_{lower} \sqrt{{μ}_{r}^{′} {ɛ}_{r}^{′}}} .$$

Preferably, to minimise the size of the waveguide antenna, the width w is approximately equal to the minimum width required to allow the waveguide antenna to operate in H₁₀ mode, i.e. so that the width w is approximately equal to

$${w}_{min} = \frac{c}{2 {f}_{lower} \sqrt{{μ}_{r}^{′} {ɛ}_{r}^{′}}} .$$

In this context, the term approximately equal may be taken to mean equal within a tolerance of 100%, 50%, 40%, 30%, 20%, 10%, 5% or 1%.

As discussed below, electromagnetic radiation having a frequency as low as 0.05 GHz or 0.1 GHz and as high as 10 GHz or 6 GHz may be used to produce image data for clinical imaging. Electromagnetic radiation having frequencies in the range 0.5 GHz to 1.5 GHz or 0.5 GHz to 4.0 GHz may be preferred. Electromagnetic radiation having a frequency of 1 GHz has been found to be particularly preferred.

The lower boundary frequency f_{lower} may be defined with respect to these theoretical values. Accordingly, the lower boundary frequency f_{lower} may be 0.05 GHz, 0.1 GHz, 0.5 GHz, 1 GHz, 1.5 GHz, 2 GHz, 3 GHz, 4 GHz or 6 GHz.

Alternatively, the lower boundary frequency f_{lower} may be defined with reference to the frequency or frequencies of electromagnetic radiation with which the tomography apparatus is operable to produce image data. Accordingly, the lower boundary frequency f_{lower} may be the lowest frequency of electromagnetic radiation with which the tomography apparatus is operable to produce image data representative of a dielectric and/or conductivity property distribution within an object located in the imaging domain.

Preferably, the width w is small, e.g. 100 mm or less, 50 mm or less, 30 mm or less, 20 mm or less, 10 mm or less, 5 mm or less, 2 mm or less or 1 mm or less. In this way, it is possible to fit more of the waveguide antennae around the imaging domain.

The above discussion assumes that the emitting and/or receiving surface of the waveguide antenna is rectangular, i.e. with the width w being a width of the rectangular emitting and/or receiving surface. However, the emitting and/or receiving surface could alternatively have a non-rectangular shape, e.g. circular. Although the above equations and inequalities have been derived with reference to a rectangular emitting and/or receiving surface, other shapes of emitting and/or receiving surface would yield similar relationships between the dimensions of the emitting and/or receiving surface and the dielectric and magnetic properties of the waveguide antenna. Therefore, the equations and inequalities derived herein can be used in conjunction with waveguide antennae which have non-rectangular emitting and/or receiving surface, with the width w being a width of the non-rectangular emitting and/or receiving surface of the waveguide antenna.

A waveguide antenna will typically emit and receive electromagnetic radiation that is linearly polarised. Therefore, a polarisation axis of a waveguide antenna may be defined as a direction relative to the waveguide antenna which is parallel to the electric field of the linearly polarised electromagnetic radiation emitted and/or received by the waveguide antenna. For a waveguide antenna having a rectangular emitting/receiving surface and operating in H₁₀ mode, the polarisation axis is parallel to the shortest side of the rectangular emitting/receiving surface.

In theory, the waveguide antennae of the tomography apparatus may be mounted so that the polarisation axes of the waveguide antennae are in any orientation with respect to each other. However, the relative orientations of the polarisation axes will have an effect on the amount of computation required to calculate the electromagnetic fields within the imaging domain between individual pairs of waveguide antennae. In particular, a complicated 3D vector electromagnetic problem has to be solved when the polarisation axes of the waveguide antennae are not aligned in the same plane. This is undesirable, because it means that a large amount of computation will be required to produce image data using the tomography apparatus.

Therefore, it may be preferable for the waveguide antennae of the tomography apparatus to be mounted so that there is a simple relationship between the relative orientations of the polarisation axes of the waveguide antennae, in order to reduce the amount of computation required to produce image data using the tomography apparatus. Preferably, the waveguide antennae of the tomography apparatus may be aligned so that their polarisation axes lie substantially in the same plane, so that the complicated 3D vector electromagnetic problem can be reduced to a 2D scalar problem (assuming that changes in polarisation occurring within the imaging domain are not taken into account).

The first aspect of the invention may further provide a waveguide antenna for use in a tomography apparatus, wherein the real component μᵣ′ of the complex relative permeability μᵣ of the waveguide antenna is substantially more than 1.

The first aspect of the invention may further provide a method of making a waveguide antenna for use in a tomography apparatus wherein the waveguide antenna is made so that the real component μᵣ′ of the complex relative permeability μᵣ of the waveguide antenna is substantially more than 1.

Preferably, the method includes: mixing a dielectric precursor material with a ferrite material; and sintering the mixture to form a substrate of the dielectric material within which the ferrite material is dispersed. Preferably, the formed substrate includes a hole.

The dielectric precursor material preferably includes one or more ceramic precursor materials so that the formed substrate is of ceramic. More preferably, the ceramic precursor material includes ferroelectric ceramic compounds such as barium titanates (e.g. BaTi₄O₉ or Ba₂Ti₉O₂₀). The dielectric/ceramic precursor material may be provided in the form of a powder.

Preferably, the method includes metallising at least one surface of the dielectric substrate. The metallising may include applying a conductive layer (e.g. of silver) to the at least one surface and sintering. Preferably, the method includes metallising all surfaces of the dielectric substrate except for an emitting and/or receiving surface and the hole (if the hole is present).

Preferred ferrite materials include nanocrystalline Fe—Co—Ni—B based materials and hexa-ferrites having the formula M(Fe₁₂O₁₉), where M is usually barium, strontium, calcium or lead.

A second aspect of the invention relates to configuring a microwave tomography apparatus so that an interface medium can be omitted.

As explained above, the imaging chambers of conventional microwave tomography apparatuses are filled with an interface medium, the purpose of which is to match the dielectric properties of the emitters and receivers to the dielectric properties of the object to be imaged. By dielectrically matching the emitters and receivers to the object to be imaged, the proportion of electromagnetic radiation from the emitters which is reflected by the surface of the object to be imaged is reduced and therefore the proportion of electromagnetic radiation from the emitter/receivers which passes through the object to be image is increased.

If the imaging chamber of a conventional microwave tomography apparatus is not filled with an interface medium, then the proportion of electromagnetic radiation that is reflected at the surface of the object to be imaged will be significantly increased. This reflected electromagnetic radiation may subsequently be incident on the receivers without interacting with the interior of the object to be imaged. As a result, electromagnetic radiation that has not interacted with the object to be imaged is used to produce image data representative of a dielectric property distribution within the object. Accordingly, the quality of the image data produced by the tomography apparatus may be reduced, or may not even be representative of the interior of the object to be imaged.

For the avoidance of doubt, an imaging chamber that is not filled with an interface medium may be filled by another medium, e.g. air.

To address these issues, the second aspect of the invention may provide a tomography apparatus according to claim 16.

The second aspect of the invention is based on the inventor's realisation that, if the imaging domain is not filled with an interface medium (e.g. because it is instead filled with air), then there is typically a significant difference between the (relatively high) speed of propagation of electromagnetic radiation which does not pass through the object to be imaged and the (relatively low) speed of propagation of electromagnetic radiation through the object to be imaged. Accordingly, electromagnetic radiation emitted by a selected one of the emitters which does not pass through the object to be imaged typically arrives at the receivers much earlier than electromagnetic radiation which does pass through the object to be imaged. This difference in arrival times can therefore be used to disregard at least some of the electromagnetic radiation that does not pass through the object to be imaged.

Therefore, the second aspect of this invention represents a fundamental change in the way in which image data is produced. Previously, the use of an interface medium was seen as essential to minimise the proportion of electromagnetic radiation which reflects within the imaging chamber. Conversely, the second aspect of this invention provides an apparatus which reduces the destructive effects of such reflected electromagnetic radiation without requiring the presence of an interface medium.

From another perspective, the second aspect of the invention can be seen as relating to emitting and receiving sequences of short pulses of electromagnetic radiation at appropriately selected intervals in order to disregard electromagnetic radiation that has not passed through the object to be imaged. In contrast, conventional microwave tomography apparatuses use what might be described as “continuous wave” or “quasi continuous wave” methods in which much longer bursts of electromagnetic radiation are emitted and received at intervals which do not allow the disregarding of electromagnetic radiation that has not passed through the object to be imaged.

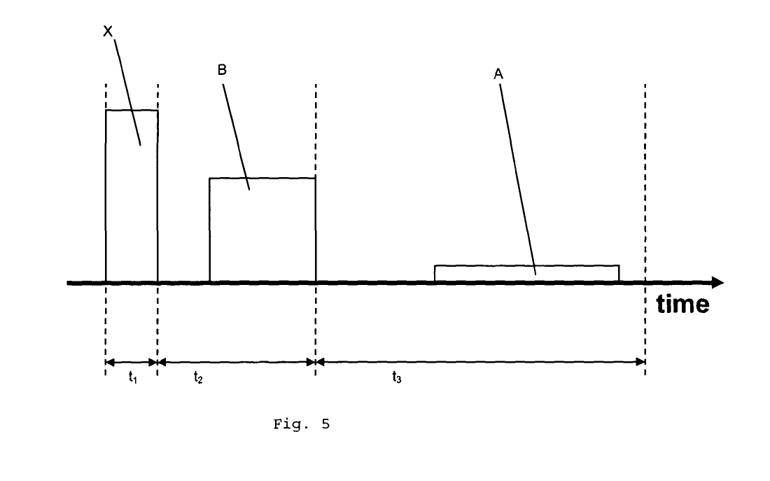

If the imaging domain is not filled with an interface medium (e.g. because it is instead filled with air), then the proportion of electromagnetic radiation from the selected emitter which does not pass through the object to be imaged will increase due to increased reflection at the surface of the object to be imaged. This means that the amplitude of the electromagnetic radiation emitted by the selected emitter which is incident on the receivers and which has not passed through the object to be imaged will typically be much larger than the amplitude of the electromagnetic radiation which has passed through the object to be imaged (this difference in amplitude is illustrated figuratively in FIG. 5).

Accordingly, to prevent electromagnetic radiation which has not passed through the object to be imaged from dominating electromagnetic radiation which has passed through the object to be imaged in the production of image data, it is preferable for the duration of the second time period t₂ to be set such that the electromagnetic radiation that is disregarded includes substantially all the electromagnetic radiation emitted by the selected emitter which is incident on the receivers and which has not passed through an object to be imaged.

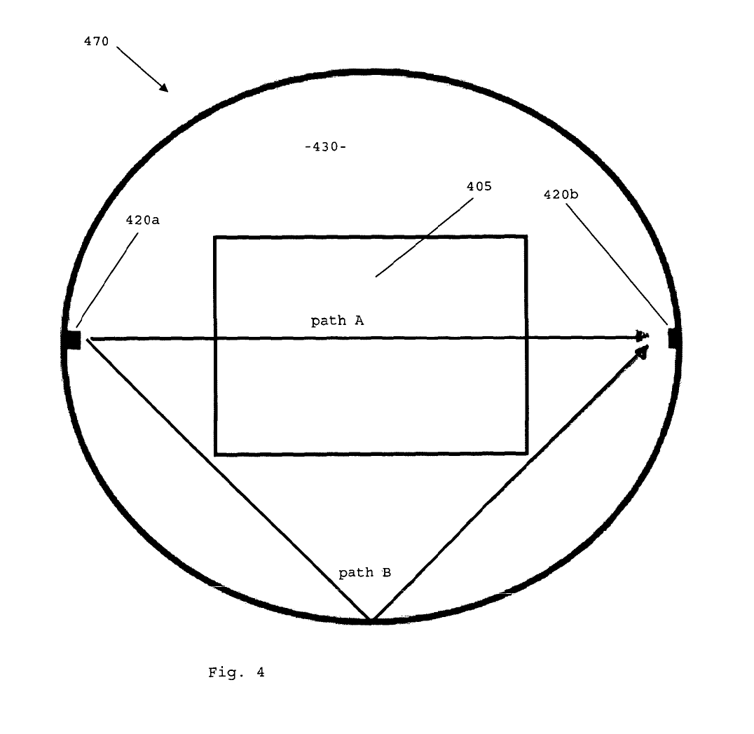

Preferably, this is achieved by setting the duration of the second time period t₂ to be greater than a time taken for electromagnetic radiation to travel from the selected emitter to one of the receivers without passing through the object to be imaged. More preferably, the duration of the second time period t₂ is set to be greater than the time taken for electromagnetic radiation to travel from the selected emitter to a receiver on an opposite side of the imaging domain without passing through the object to be imaged (e.g. the time taken for electromagnetic radiation to travel along path B illustrated in FIG. 4).

For clinical imaging of human tissue, the time taken for electromagnetic radiation to travel from the selected emitter to a receiver on an opposite side of the imaging domain without passing through the object to be imaged may be of the order of 1 nanosecond (see discussion relating to FIG. 4 below). Accordingly, the duration of the second time period t₂ may be set to be 1 ns or more, 2 ns or more, 5 ns or more, or ns or more.

Preferably, the durations of the first and second time periods t₁,t₂ are set such that the duration of the combined time period t₁+t₂ is such that the electromagnetic radiation that is disregarded includes substantially none of the electromagnetic radiation from the selected emitter which is incident on the receivers and which has passed through the object to be imaged.

Preferably, this is achieved by setting the durations of the first and second time periods t₁,t₂ such that the duration of the combined time period t₁+t₂ is substantially equal to or less than a time taken for electromagnetic radiation to travel from the selected emitter to one of the receivers whilst passing through the object to be imaged. More preferably, the durations of the first and second time periods t₁,t₂ are set such that the duration of the combined period t₁+t₂ is substantially equal to or less than a time taken for electromagnetic radiation to travel from the selected emitter to a receiver on an opposite side of the imaging domain whilst passing through the object to be imaged (e.g. the time taken to travel along path A illustrated in FIG. 4).

For clinical imaging of human tissue, the time taken for electromagnetic radiation to travel from the selected emitter to a receiver on an opposite side of the imaging domain whilst passing through the object to be imaged may be of the order of 10 nanoseconds (see discussion relating to FIG. 4 below). Accordingly, the durations of the first and second time periods t₁,t₂ may be set such that the duration of the combined time period t₁+t₂ is substantially equal to or less than 20 ns, 15 ns, 10 ns or 5 ns.

Preferably, the tomography apparatus is configured so that electromagnetic radiation that is incident on the receivers during a third time period t₃ subsequent to the second time period t₂ is used for the production of said image data when the apparatus is in use, the durations of the first, second and third time periods t₁,t₂,t₃ being set such that the electromagnetic radiation that is used for the production of image data includes at least some of, preferably substantially all of, the electromagnetic radiation emitted by the selected emitter which is incident on the receivers and which has passed through the object to be imaged.

If there is a large difference in the time taken for electromagnetic radiation which does and does not pass through the object to be imaged to travel from the selected emitter to the receivers, then it may be possible to set the durations of the first and second time periods t₁,t₂ so that substantially all the electromagnetic radiation incident on the receivers which has not passed through the object to be imaged is disregarded, and to set the third time period t₃ so that so that substantially all the electromagnetic radiation incident on the receivers which has passed through the object to be imaged is used for the production of image data.

However, if there is only a small difference in travel times, e.g. because the object to be imaged is small, or if the first time period t₁ is relatively long, then electromagnetic radiation which has passed through the object to be imaged may be incident on the receivers at the same time as electromagnetic radiation which has not passed through the object to be imaged. In such circumstances, it is preferable to set the duration of the second time period t₂ so that the electromagnetic radiation that is disregarded includes substantially all the electromagnetic radiation emitted by the selected emitter which is incident on the receivers and which has not passed through an object to be imaged, even though this may result in some electromagnetic radiation which has passed through the object to be imaged being disregarded. This is preferable as it helps to prevent electromagnetic radiation which has not passed through the object to be imaged from dominating electromagnetic radiation which has passed through the object to be imaged in the production of image data since, as explained above, the amplitude of electromagnetic radiation incident on the receivers which has not passed through the object to be imaged is typically much larger than the amplitude of the electromagnetic radiation incident on the receivers which has passed through the object to be imaged.

Preferably, the duration of the first time period t₁ is short, so that the amount of electromagnetic radiation from the selected emitter which has passed through the object to be imaged and is incident on the receivers at the same time as electromagnetic radiation which has not passed through the object to be imaged, is as small as possible (and preferably substantially zero). This may be achieved by setting the duration of the first time period t₁ to be equal to (or less than) a time taken for electromagnetic radiation to travel from the selected emitter to one of the receivers without passing through the object to be imaged. More preferably, the duration of first time period t₁ is set to be equal to or less than a time taken for electromagnetic radiation to travel from the selected emitter to a receiver on an opposite side of the imaging domain whilst passing through the object to be imaged (e.g. the time taken to travel along path B illustrated in FIG. 4).

For clinical imaging of human tissue, the time taken for electromagnetic radiation to travel from the selected emitter to a receiver on an opposite side of the imaging domain without passing through the object to be imaged may be of the order of 1 nanosecond (see discussion relating to FIG. 4 below). Accordingly, the duration of the first time period t₁ may suitably be 5 ns or less, 2 ns or less, or 1 ns or less.

There are several possible configurations in which the tomography apparatus may be configured so that electromagnetic radiation incident on the receivers during the second time period t₂ is disregarded for the production of the image data. For example, the measuring means may be configured not to produce measurement data representative of electromagnetic radiation incident on the receivers during the second time period t₂. Alternatively, the processing means may be configured not to use measurement data representative of electromagnetic radiation incident on the receivers during the second time period t₂.

Of these possible configurations, it is preferable for the measuring means to be configured not to produce measurement data representative of electromagnetic radiation incident on the receivers during the second time period t₂, as this helps to avoid any circuitry which may be in the measurement means from being overloaded by the electromagnetic radiation which has not passed through the object to be imaged. Overloading of such circuitry is a risk because the amplitude of electromagnetic radiation which has not passed through the object to be imaged is typically much larger than the amplitude of electromagnetic radiation which has passed through the object to be imaged (for reasons explained above).

The sequence of time periods t₁,t₂,t₃ during which the electromagnetic radiation is emitted, disregarded and received may be repeated for the selected emitter in order to provide measurement data having a desired signal to noise ratio. This can then be repeated with each of the emitters being selected in turn.

The second aspect of the invention may also provide a method of producing image data which corresponds to the above described apparatus. Accordingly, there may be provided a method according to claim 27.

Preferably, the method includes a further step of selecting another emitter and repeating the steps of emitting electromagnetic radiation and producing measurement data until each emitter has been selected.

A third aspect of the invention relates to reducing the size of a microwave tomography apparatus.

As explained above, it is conventional for a microwave tomography apparatus to include an imaging chamber having one or more walls which define a boundary of its imaging domain.

The imaging chamber of a conventional microwave tomography apparatus is preferably large in order to minimise the impact of boundary effects. In particular, cylindrical imaging chambers of known microwave tomography apparatuses are axially long, in order to reduce the proportion of electromagnetic radiation which reflects back into the imaging chamber from the boundaries at opposite axial ends of the cylindrical imaging chamber (these boundaries may, for example, include a boundary between an interface medium and air and/or a boundary between an interface medium and a wall of the imaging chamber).

Reflected radiation can reduce the quality of the image data produced by the tomography apparatus. Accordingly, it is difficult to reduce the size of a conventional imaging chamber, without reducing the quality of the image data produced by the tomography apparatus.

To address these issues, the third aspect of the invention may provide a tomography apparatus according to claim 29.

Because the lining reduces the amount of electromagnetic radiation which reflects from the walls and onto the receivers when the apparatus is in use, the size of the imaging chamber can be reduced without unduly reducing the quality of the image data produced. In particular, when the imaging chamber is tubular, e.g. cylindrical, it allows the axial length of the imaging chamber to be reduced without necessarily reducing the quality of the image data produced by the tomography apparatus.

In some embodiments, the imaging chamber may be tubular, e.g. cylindrical. Particularly troublesome reflections can be caused by boundaries at the axial ends of such imaging chambers. Therefore, it is preferable for the lining to have a first portion located at or adjacent to one axial end of the imaging chamber, and further preferable for the lining to have a second portion located at or adjacent to an other axial end of the imaging chamber, preferably such that the two portions of the lining are on opposite sides of the plurality of emitters and the plurality of receivers. This has been found to be a particularly effective way to reduce the proportion of electromagnetic radiation which reflects back into the imaging chamber from the boundaries at opposite axial ends of a tubular imaging chamber. Preferably, each of the portions is dimensioned so as to occupy a substantial portion, preferably more than half, of the cross sectional area of the imaging chamber.

Preferably, one or more portions of the lining extend unbroken around a periphery of the imaging chamber. For example, if the imaging chamber is cylindrical, then the one or more portions of the lining may extend unbroken around the circumference of the imaging chamber.

Preferably, the lining is arranged to absorb electromagnetic radiation used by the apparatus, e.g. to absorb electromagnetic radiation having a frequency in the range 0.05 GHz to 10 GHz. To this end, the lining may have an attenuation coefficient which is higher than that of human tissue at a frequency in the range 0.05 GHz to 10 GHz. For example, myocardial tissue has an attenuation coefficient of about 0.3 cm⁻¹ at a frequency of 1 GHz.

The attenuation coefficient of the lining can be increased by increasing the imaginary component ∈ᵣ″ of the complex relative permittivity ∈ᵣ of the lining. Therefore, preferably, the imaginary component ∈ᵣ″ of the complex relative ∈ᵣ permittivity of the lining is larger than the imaginary component ∈ᵣ″ of the complex relative permittivity ∈ᵣ of human tissue at a frequency in the range 0.05 GHz to 10 GHz.

Preferably, the lining has a complex relative permittivity ∈ᵣ whose real component ∈ᵣ′ is matched to, i.e. is substantially equal to, the real component ∈ᵣ′ of the complex permittivity ∈ᵣ of the object to be imaged, e.g. human tissue. Consequently, if the lining is proportioned so that it is in contact with an object to be imaged when the apparatus is in use, the proportion of electromagnetic radiation reflected at the boundaries between the lining and the object to be imaged can be reduced. In this way, the lining may be seen as functioning as the interface medium.

Preferably, the lining includes an aqueous solution including one or more components selected from the group consisting of: one or more salts, fatty emulsion, sugar or glycerol. By varying the proportions of these one or more components, it is possible to increase the imaginary component ∈ᵣ″ of the complex relative permittivity, and therefore to increase the attenuation coefficient, of the aqueous solution.

Preferably, the lining includes a lining material into which the aqueous solution is absorbed. The lining material preferably includes a foam. In this way, a low-cost disposable lining can be provided, which may be of particular use in clinical environments where sterility is an important consideration.

Preferably, the lining has a shape which encourages internal reflections within the lining, so as to reduce the proportion of electromagnetic radiation which reflects from the walls and onto the receivers when the apparatus is in use.

For example, the shape of the lining may define a plurality of pyramids, so as to encourage such internal reflections.

A fourth aspect of the invention relates to reducing the size and cost of a microwave tomography apparatus.

For reasons explained previously, known microwave tomography apparatuses tend to be large, unwieldly, and expensive.

To address these issues, the fourth aspect of the invention may provide a tomography apparatus according to claim 38.

Preferably, the source is a multi-channel network analyser. A multi-channel network analyser is a product used mainly in the telecommunications industry.

By having a source of electromagnetic radiation which also acts as the measuring means, particularly where the source of electromagnetic radiation is a multi-channel network analyser, it has been found that the speed at which measurement data is produced and the accuracy of the measurement data produced can be improved when compared with a conventional microwave tomography apparatus in which the source and the measuring means are separate.

A fifth aspect of the invention relates to providing a microwave tomography apparatus that is smaller and more versatile.

Accordingly, the fifth aspect of the invention may provide a tomography apparatus according to claim 40.

By having emitters and/or receivers that are independently movable with respect to each other, it is possible to apply the emitters and/or receivers directly to an object to be imaged. This may find particular use in a clinical environment, where the emitters and/or receivers can be applied to a part of a human which it is desirable to image.

In performing tomography, it is important that the positions of all emitters and receivers are known in order to produce the image data. Accordingly, each independently movable emitter and/or receiver may be provided with a position determining means for producing position data representative of the relative positions of the emitter and/or receiver. The position determining means may further be for producing position data representative of the relative orientations of the emitter and/or receiver. The position data can then be communicated to the processing means where it may be used in the production of the image data.

Preferably, in use, the independently movable emitters and/or receivers are applied to the object to be imaged with their polarisation axes aligned, so that the amount of computation required to calculate the electromagnetic fields between the emitters and receivers during the production of image data is kept as small as possible. However, if the polarisation axes are not aligned, then it would still be possible to calculate the electromagnetic fields between the emitters and receivers using the position data representative of the relative orientations of the emitter and/or receiver, but there would be an increase in the amount of computation required to calculate the electromagnetic fields between the emitters and receivers during the production of image data.

Each independently movable emitter and/or receiver may include a tissue contact sensor for determining its emitter and/or receiver is in contact with human tissue. Each independently movable emitter and/or receiver may include an actuator for adjusting the position of its emitter and/or receiver.

Preferably, the apparatus includes a fluid medium for providing an interface between the emitting and/or receiving surface of each emitter and/or receiver and the object to be imaged.

Preferably, the fluid medium has a complex relative permittivity whose real component ∈ᵣ′ is matched to, i.e. substantially equal to, the real component of the complex permittivity of the object to be imaged. In this way, the proportion of electromagnetic radiation reflected at the boundaries between the object to be imaged is reduced. Consequently, the amount of electromagnetic radiation which leaks into the surroundings is also reduced.

Preferably, the fluid medium has an attenuation coefficient which is greater than that of the object to be imaged. In this way, the amount of electromagnetic radiation which leaks into the surroundings is reduced. Attenuation coefficient can be increased by increasing the imaginary component ∈ᵣ″ of the complex relative permittivity. Therefore, the attenuation coefficient of the fluid medium may include a salt to increase the imaginary component ∈ᵣ″ of the complex relative permittivity of the fluid medium.

The fluid medium may include one or more components selected from the group consisting of: one or more salts, fatty emulsion, sugar or glycerol. By varying the proportions of these one or more components, it is possible to control the dielectric properties of the fluid medium.

The fluid medium may be provided in the form of a gel.

Preferably, a tomography apparatus according to any aspect of the invention is operable to use electromagnetic radiation having a frequency 0.05 GHz or higher, 0.1 GHz or higher, 0.5 GHz or higher, 1 GHz or higher, or 1.5 GHz or higher. Preferably, tomography apparatus is operable to use electromagnetic radiation having a frequency 10 GHz or lower, 6 GHz or lower, 4 GHz or lower, 1.5 GHz or lower, or 1 GHz or lower. Such frequencies have been found particularly useful for clinical imaging, for reasons discussed below.

Preferably, a tomography apparatus according to any aspect of the invention includes a source of electromagnetic radiation. Preferably, each emitter of the tomography apparatus is arranged to emit electromagnetic radiation produced by the source. Preferably, the source of electromagnetic radiation is operable to produce electromagnetic radiation having a frequency within a range of frequencies according to the preceding paragraph.

Preferably, a tomography apparatus according to any aspect of the invention has a control means for controlling the apparatus to emit electromagnetic radiation from each of the emitters and to receive electromagnetic radiation at the receivers.

Preferably, a tomography apparatus according to any aspect of the invention has a measuring means for producing measurement data representative of (i) electromagnetic radiation emitted by each of the emitters and (ii) electromagnetic radiation received by the receivers after it has interacted with an object located in the imaging domain. In this way, the measurement data representative of electromagnetic radiation emitted by each of the emitters can be used to normalise the measurement data representative of electromagnetic received by the receivers. This prevents the production of image data from being unduly influenced by any variation in the amount of electromagnetic radiation emitted by the emitters. Although the same effect could be achieved by calibrating the tomography apparatus to emit electromagnetic radiation having a predetermined amplitude and phase from each of the emitters, it would be very difficult and expensive to calibrate a tomography apparatus in this way in practice.

Preferably, a tomography apparatus according to any aspect of the invention has a measuring means arranged to produce measurement data representative of (i) the amplitude, phase and/or polarisation of electromagnetic radiation emitted by the emitters and/or (ii) the amplitude, phase and/or polarisation of electromagnetic radiation received by the receivers after it has interacted with an object located in an imaging domain. Preferably, the measurement data is representative of at least the amplitude and phase, and preferably also the polarisation, of electromagnetic radiation, as this allows higher quality image data to be produced.

Preferably, a tomography apparatus according to any aspect of the invention includes a plurality of emitter/receivers, each emitter/receiver being capable of acting as a respective one of the emitters and a respective one of the receivers of the tomography apparatus.

Preferably, a tomography apparatus according to any aspect of the invention includes a control means arranged to control the apparatus according to a plurality of measurement cycles, each measurement cycle including the steps of:

(a) emitting electromagnetic radiation from a selected one of the emitters;

(b) producing measurement data representative of electromagnetic radiation received by the receivers after it has interacted with an object located in the imaging domain;

(c) selecting another emitter and repeating steps (a) and (b) until each emitter has been selected.

Preferably, the control means is arranged to control the apparatus such that each measurement cycle is followed by a further step (d) of producing image data representative of a dielectric and/or conductivity property distribution within the object located in the imaging domain based on the measurement data.

Preferably, a tomography apparatus according to any aspect of the invention includes has a processing means arranged to produce image data representative of a complex permittivity distribution within an object located in the imaging domain based on measurement data from the measuring means. Complex permittivity is a well-known property that is representative of both a dielectric property (permittivity) and a conductivity property (electrical conductivity).

A tomography apparatus according to any aspect of the invention may include an imaging chamber having one or more walls which define a boundary of the imaging domain. The imaging chamber may be mounted to a base so that the image chamber can be rotated into any orientation with respect to the base, e.g. by one or more arms. In this way, the tomography apparatus may be useful in a clinical environment. Having an imaging chamber rotatable in this way may be particularly useful when the imaging domain need not be filled with interface medium, e.g. a tomography apparatus according to the second aspect of the invention.

The invention may provide a method of producing image data using a tomography apparatus according to any aspect of the invention.

A sixth aspect of the invention relates to providing an improved method for producing image data using measurement data from a tomography apparatus, the measurement data being representative of electromagnetic radiation received by a plurality of receivers spatially distributed around an imaging domain.

The method may include a step of determining an optimised value for the complex permittivity within the imaging domain when the imaging domain is empty by comparing experimental measurement data from the tomography apparatus with theoretical measurement data calculated using a plurality of trial values for the permittivity of the imaging domain when the imaging domain is empty. The experimental measurement data may, for example, be provided in the form of the experimental empty measurement matrix E^{EXP}(i,j,k) described below. The theoretical data may, for example, be provided in the form of the theoretical empty measurement matrixes E^{THR}(i,j,k) described below.

The method may include a step of using position data representative of the relative positions of a plurality of independently movable emitters and/or receivers of the tomography apparatus in the production of experimental data representative of the electromagnetic fields scattered by an object located in the imaging domain. In this way, the experimental data can be produced so as to take account of the positions of the plurality of independently movable emitters and/or receivers. The experimental data may, for example, be provided in the form of the experimental scattered field matrixes S^{EXP}(i,j,k) described below.

The method may include a step of using position data representative of the relative positions of a plurality of independently movable emitters and/or receivers of the tomography apparatus in the production of theoretical data representative of the electromagnetic fields scattered by an object located in the imaging domain. In this way, the theoretical data can be produced so as to take account of the positions of the plurality of independently movable emitters and/or receivers. The theoretical data may, for example, be provided in the form of the theoretical scattered fields matrixes S^{THR}(i,j,k) described below.

The method may include a step of switching between using a first algorithm for reconstructing a distribution of complex permittivity, a second algorithm for reconstructing a distribution of complex permittivity and, optionally, a third algorithm for reconstructing a distribution of complex permittivity. The switching may, for example, be performed by the inverse solver switch described below.

The method may include a step of calculating (or “reconstructing”) a plurality of distributions of complex permittivity, each distribution of complex permittivity being calculated using measurement data that has been produced using a respective frequency of electromagnetic radiation. Preferably, at least one of the distributions of complex permittivity is calculated based on: (i) a distribution of complex permittivity that has been calculated using measurement data that has been produced using a different frequency of electromagnetic radiation; (ii) a homogeneous distribution; or (iii) a plurality of distributions of complex permittivity that have been calculated using measurement data that has been produced using a plurality of different frequencies of electromagnetic radiation.

The method may include a step of calculating (or “reconstructing”) a plurality of distributions of complex permittivity, each distribution of complex permittivity being calculated using measurement data that has been produced for a respective frame of image data. Preferably, at least one of the distributions of complex permittivity is calculated based on: (i) a distribution of complex permittivity that has been calculated using measurement data that has been produced for a a different frame of image data; (ii) a homogeneous distribution; or (iii) a plurality of distributions of complex permittivity that have been calculated using measurement data that has been produced for a plurality of different frames of image data.

Preferably, the method includes producing image data representative of a complex permittivity distribution within an object located in the imaging domain, e.g. based on one or more (e.g. three-dimensional) distributions of complex permittivity calculated using the measurement data.

Preferably, the method includes a step of producing more than one frame of image data, each frame of image data being representative of a complex permittivity distribution within an object located in the imaging domain at a different time, e.g. based on a plurality of (e.g. three-dimensional) distributions of complex permittivity calculated for each frame of image data using measurement data produced at a respective time.

The image data may include values representative of the “absolute” complex permittivity distribution within an object located in the imaging domain, i.e. values representative of the actual complex permittivity distribution within the object. The values representative of “absolute” complex permittivity may be produced e.g. by an “absolute imaging” module e.g. as discussed below.

Additionally or alternatively, the image data preferably includes values representative of the change, if any, in the complex permittivity distribution within an object located in the imaging domain over time. For example, the values may be representative of the difference, if any, between the complex permittivity distribution within an object located in the imaging domain at two (or more) different times. Such values may be produced, for example, by subtracting an (e.g. three-dimensional) distribution of complex permittivity calculated using measurement data produced at a first time (e.g. for a first frame of image data) from an (e.g. three-dimensional) distribution of complex permittivity calculated using measurement data produced at a second time (e.g. for a second frame of image data). The values representative of the change, if any, in complex permittivity distribution within an object located in the imaging domain over time may be produced e.g. by a “differential imaging” module e.g. as discussed below.

To put this in other words, the method may include a step of producing image data representative either of absolute values of complex permittivity or of “relative” values of complex permittivity (i.e. values showing the relative differences in complex permittivity between the L frames of image data).

Image data including values representative of the change, if any, in complex permittivity distribution within an object located in the imaging domain over time may be useful, e.g., for diagnostic purposes.

The method may further include displaying the image data on a display.

The sixth aspect of the invention may further provide a computer program executable to perform any one or more of the above described method steps and/or a computer readable medium on which the computer program is stored.

The invention also includes any combination of the aspects and preferred features described herein, except where such a combination is clearly impermissible or expressly avoided.

Unless otherwise indicated, the terms approximately equal and substantially equal can be defined as equal to within a tolerance of 100%, 50%, 40%, 30%, 20%, 10% or 5% or 1%.

Embodiments of our proposals are discussed below, with reference to the accompanying drawings in which:

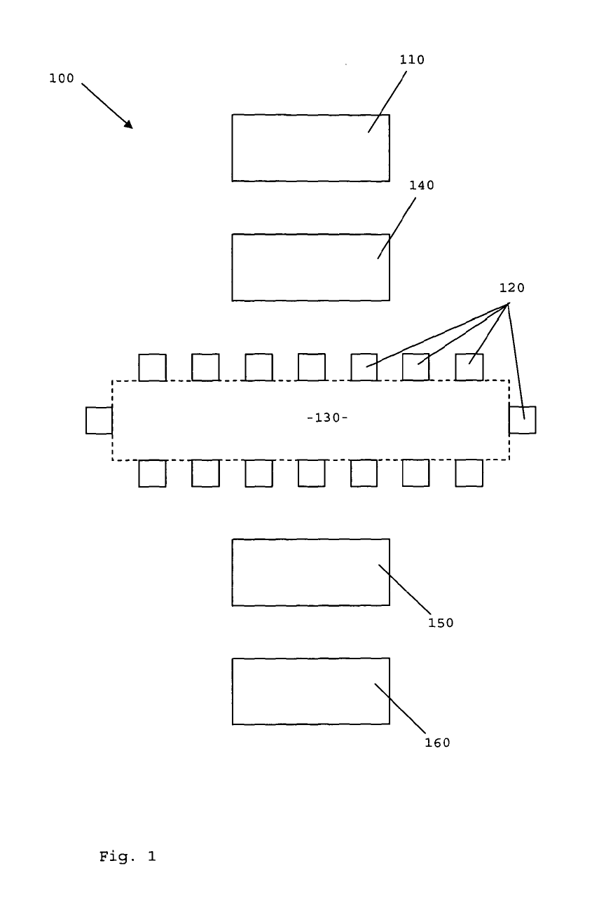

FIG. 1 shows symbolically a tomography apparatus which may be used with the present invention.

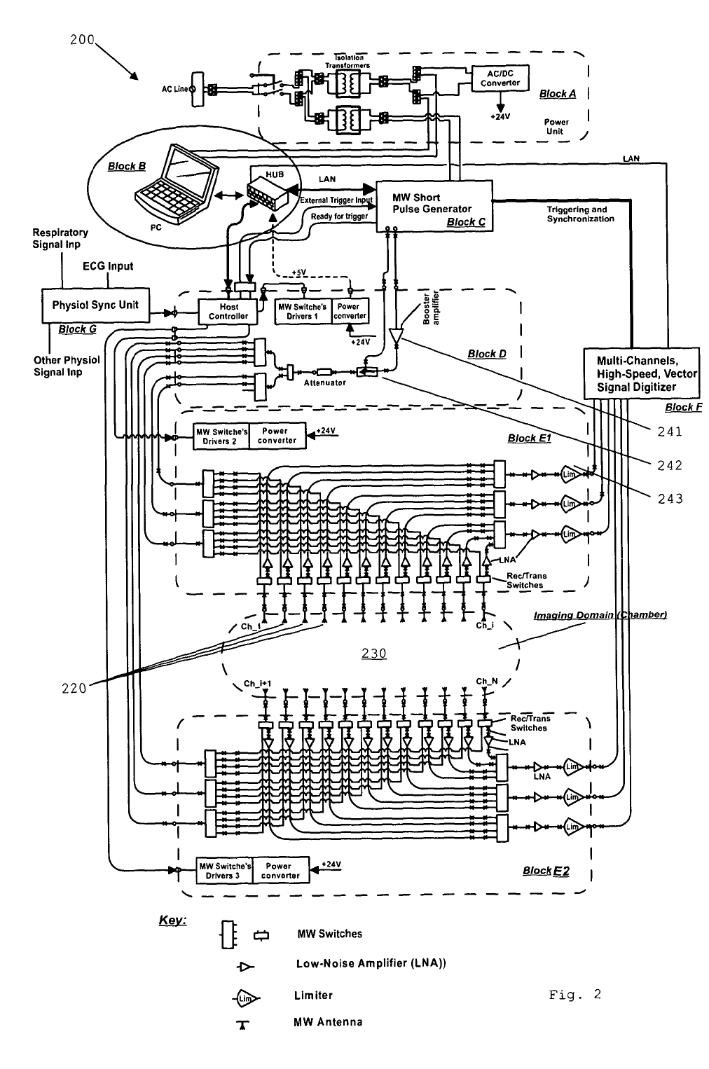

FIG. 2 shows schematically a tomography apparatus which may be used with the present invention.

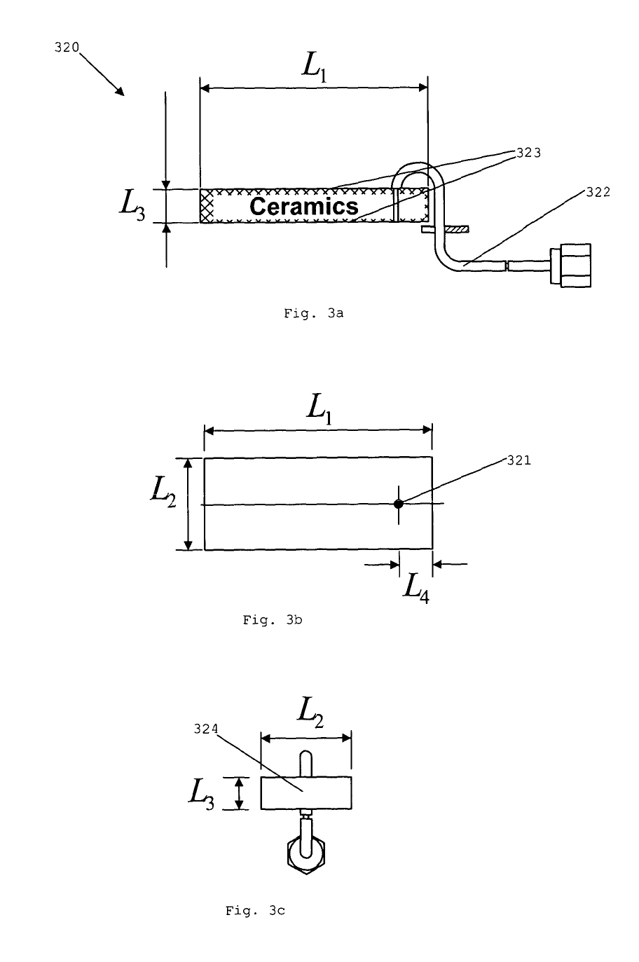

FIGS. 3a-c are respectively side, above and front views of an waveguide antenna which may be used with the present invention.

FIG. 4 shows schematically the propagation of electromagnetic radiation through an imaging chamber.

FIG. 5 is illustrative of the electromagnetic radiation emitted and incident on emitter/receivers of the imaging chamber of FIG. 4 over time.

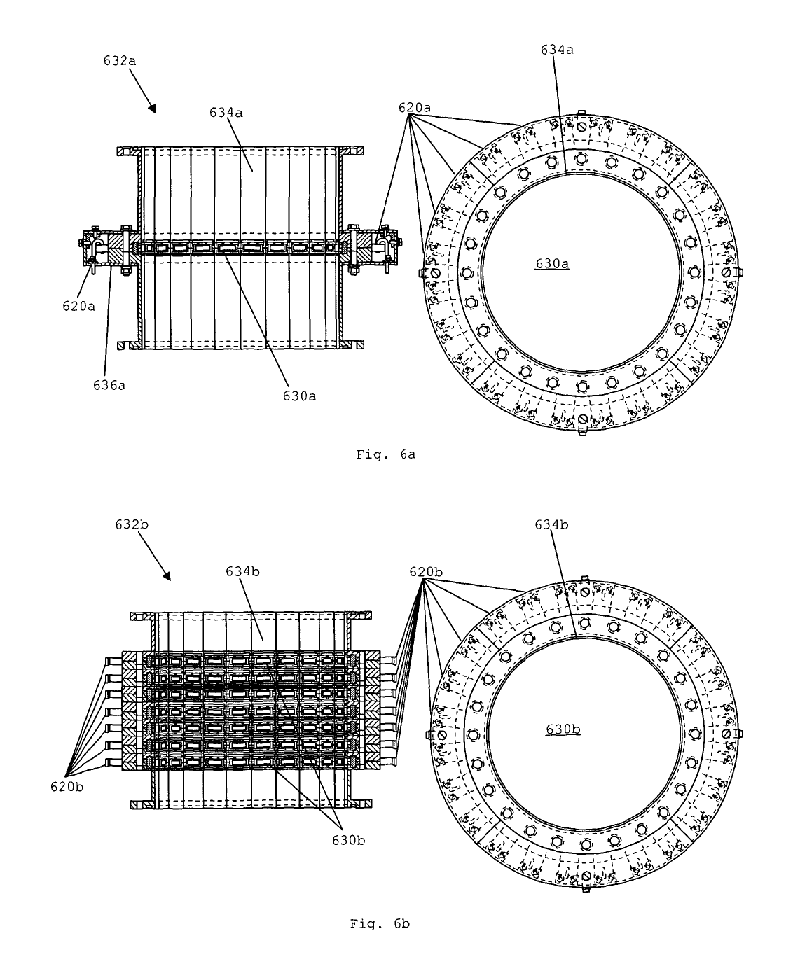

FIGS. 6a and 6b show imaging chambers which may be used with the present invention.

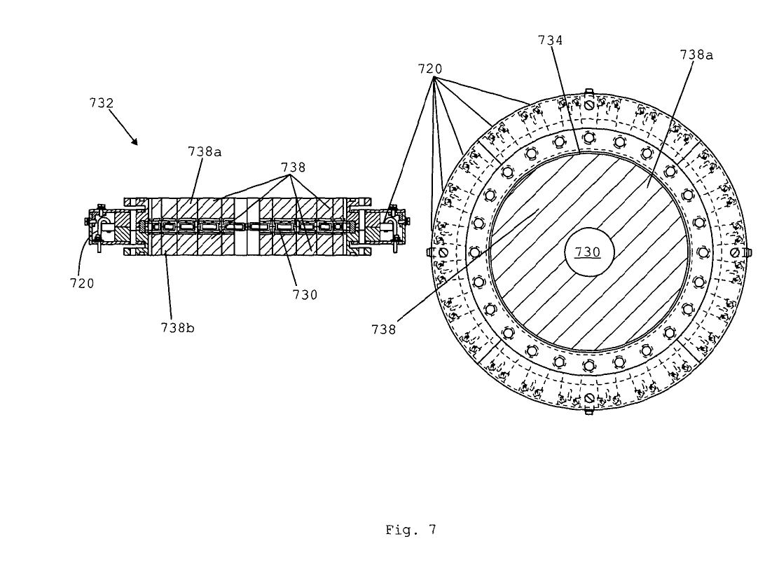

FIG. 7 shows an alternative imaging chamber which may be used with the present invention.

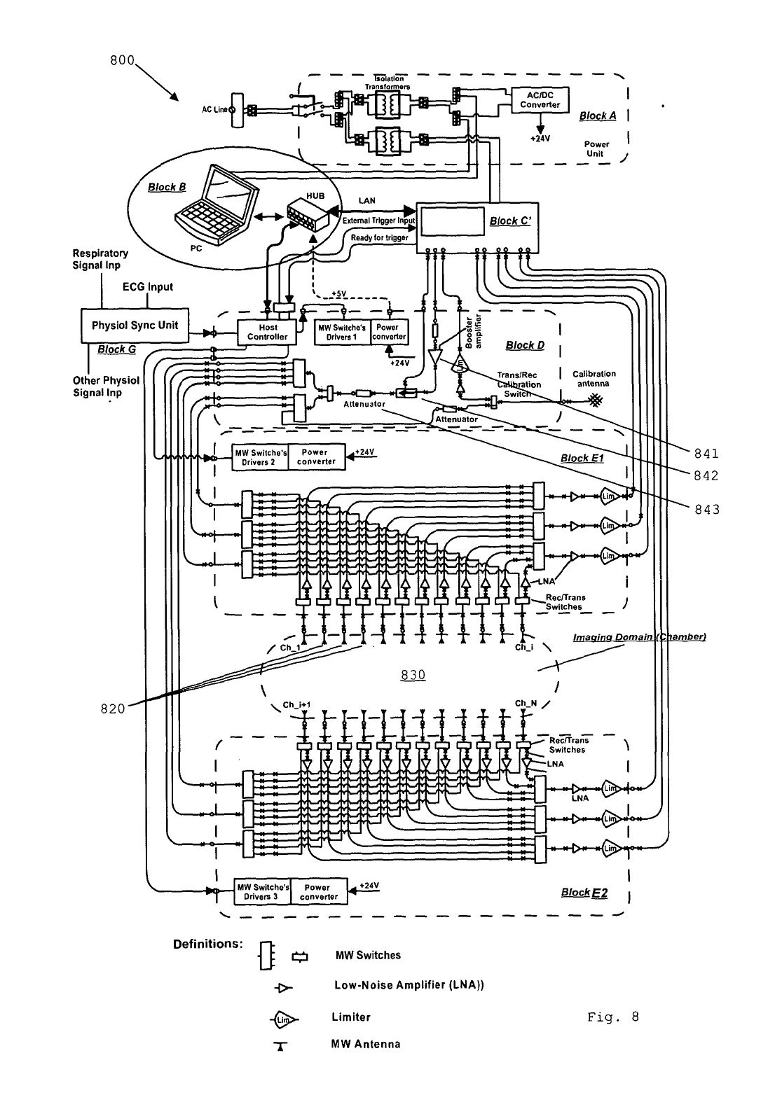

FIG. 8 shows schematically another tomography apparatus which may be used with the present invention.

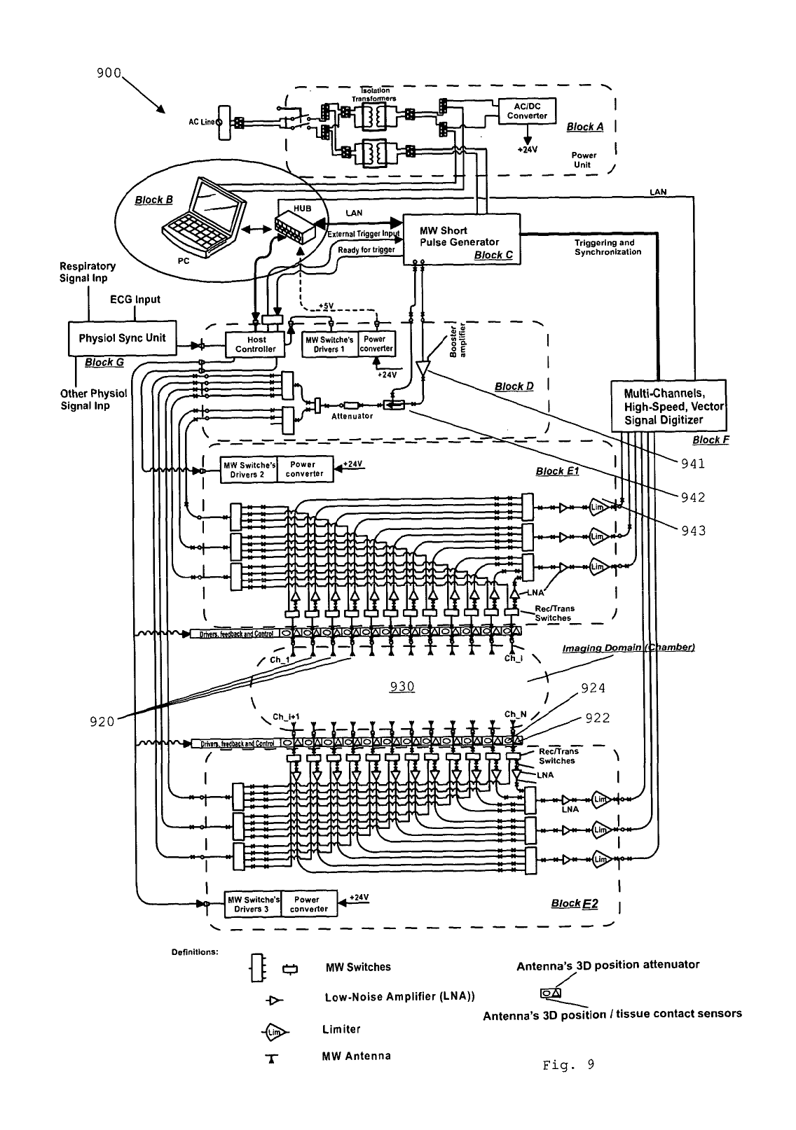

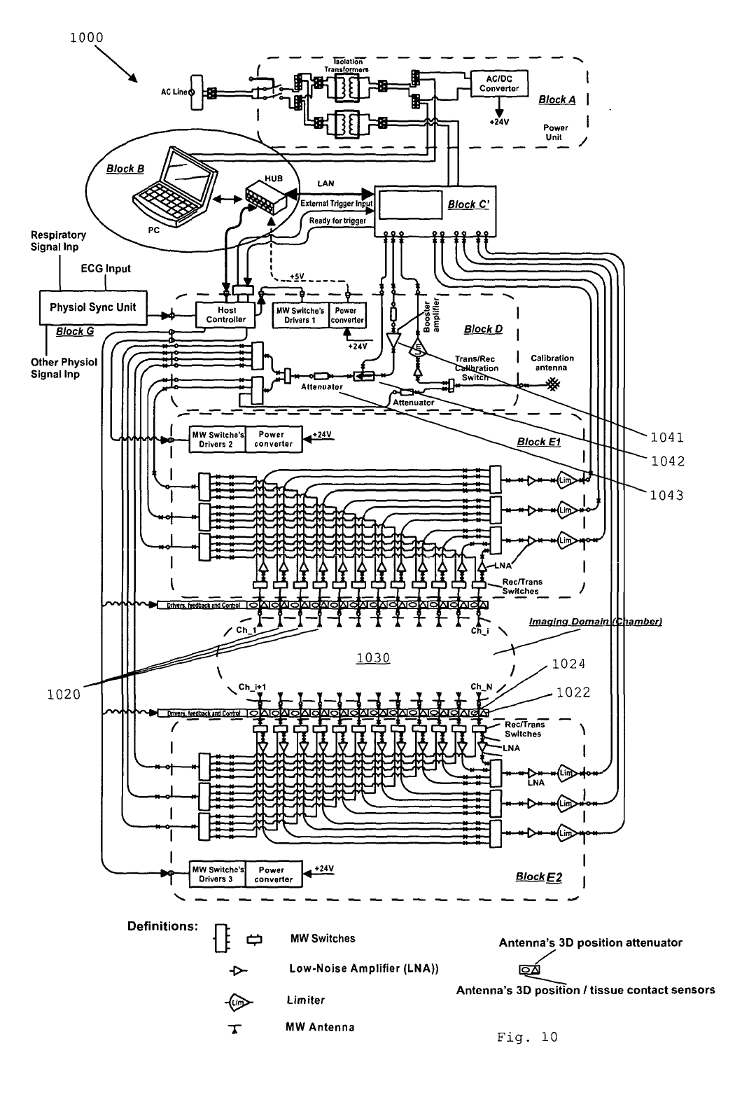

FIGS. 9 and 10 show schematically further tomography apparatuses which may be used with the present invention.

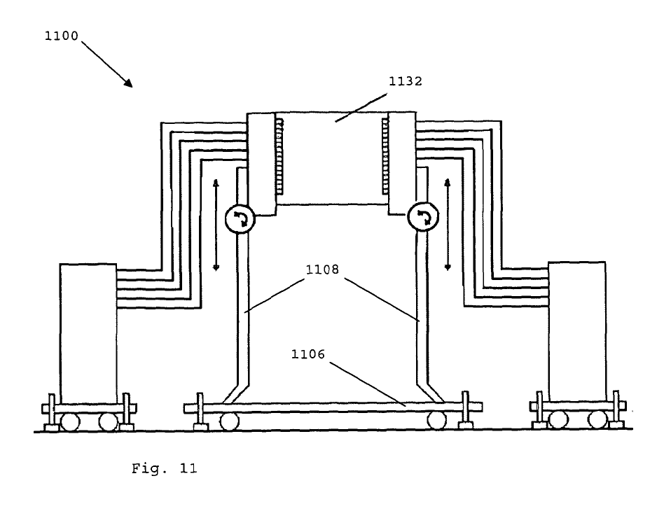

FIG. 11 shows schematically another tomography apparatuses which may be used with the present invention.

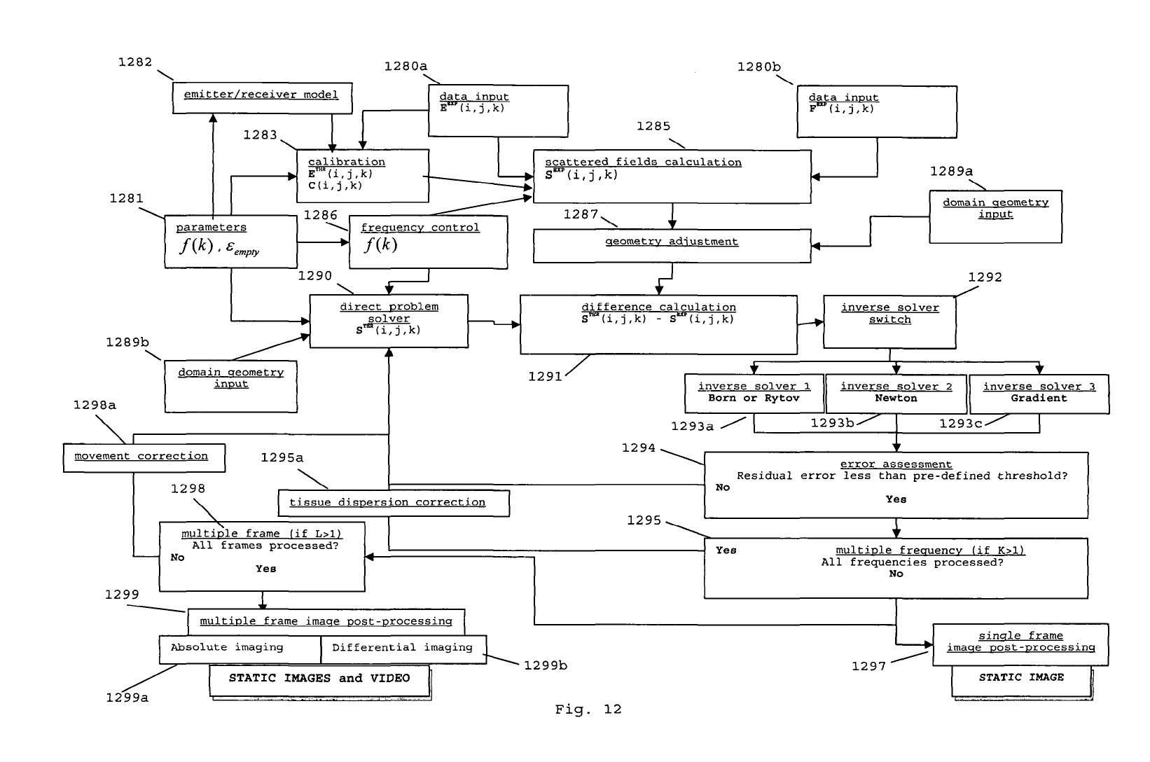

FIG. 12 is a block diagram illustrating a computer program for producing image data, which may be used with the present invention.

FIG. 1 shows symbolically a tomography apparatus 100 which may be used with the present invention.

The tomography apparatus 100 has a source 110 of electromagnetic radiation. The source 110 may be operable to produce electromagnetic radiation having a frequency in the range 0.05 GHz to 10 GHz. At these frequencies, the dielectric properties of biological tissue vary according to biological properties of the tissue. Therefore, using electromagnetic radiation having these frequencies to image biological tissue allows the different biological properties of biological tissue to be distinguished.

The tomography apparatus 100 also has a plurality of emitter/receivers 120 for emitting and receiving electromagnetic radiation. Although only sixteen emitter/receivers 120 are shown in FIG. 1, this is only symbolic. In practice, a larger or smaller number of emitter/receivers 120 may be provided. Each emitter/receiver 120 can be viewed as functioning as both an emitter and a receiver.

The emitter/receivers 120 are spatially distributed around an imaging domain 130 for locating an object to be imaged (not shown) therein. The object to be imaged may include biological tissue, e.g. human tissue, which may include a part of human anatomy, such as a torso, head, breast, arm or leg.

The emitter/receivers 120 may be spatially distributed in a single plane, e.g. as shown in FIGS. 6a, and 7, so as to facilitate the production of two-dimensional (2D) image data, i.e. a cross-section, of an object. Alternatively, the emitter/receivers 120 may be spatially distributed in three dimensions (3D), e.g. in a plurality of planes as shown in FIG. 6b or in another fashion, so as to facilitate the production of 3D image data of an object.

In some embodiments, the tomography apparatus 100 may include an imaging chamber (not shown) having one or more walls which define a boundary of the imaging domain 130. The imaging chamber might have a geometrical form suited to its intended purpose. A cylindrical shape maybe preferred for imaging a thorax. A helmet-like shape may be preferred for imaging a brain, e.g. for diagnosis of a stroke. Examples of imaging chambers are shown in FIGS. 6a, 6b and 7.

The tomography apparatus 100 has a control means 140 for controlling the apparatus 100 to emit electromagnetic radiation produced by the source 110 from each of the emitter/receivers 120.

The tomography apparatus 100 has a measuring means 150 for producing measurement data representative of (i) electromagnetic radiation emitted by each of the emitter/receivers 120 and (ii) the electromagnetic radiation received by the emitter/receivers 120 after it has interacted with an object located in the imaging domain 130. The measurement data is preferably representative of the amplitude, phase and polarisation of electromagnetic radiation emitted by, and incident on, the emitter/receivers 120. Measurement data representative of the amplitude and phase of electromagnetic radiation may be produced by measuring electromagnetic fields. Measurement data representative of the polarisation of electromagnetic radiation may be produced based on the relative orientations of the polarisation axes of the emitter/receivers 120. The measurement data may be stored in the form of a matrix.

The tomography apparatus 100 has a processing means 160 for producing image data representative of a dielectric and/or conductivity property distribution within an object located in the imaging domain 120 based on measurement data from the measurement means 150. Preferably, the dielectric and/or conductivity property distribution produced by the processing means 160 is a complex permittivity distribution.

The image data produced by the processing means 160 may be static image data representative of a dielectric and/or conductivity property distribution with the imaged object at a given point in time. Alternatively, the image data produced by the processing means 160 may be video image data, showing how a dielectric and/or conductivity property distribution changes over a period of time. The dielectric and/or conductivity property distribution may be indicative of absolute or relative values of a dielectric and/or conductivity property (e.g. complex permittivity) within the imaged object. Video image data may be of particular interest for circulatory related diagnostics, for example in cardiac or brain imaging. As have been shown previously by the inventor and his colleagues, the dielectric properties of tissues are sensitive to its blood content, hypoxia, ischemia and infarction.

The image data from the processing means 160 may be provided to a display (not shown), so that the dielectric and/or conductivity property distribution within an imaged object can be visually displayed. In clinical environments where the imaged object may include a part of human anatomy, the displayed dielectric and/or conductivity property distribution may be used for non-invasive detection of physiological and pathological conditions, such as tissue hypoxia, ischemia, infarction and tissue malignancies.

In use, the control means 140 may control the tomography apparatus 100 to operate in accordance with one or more measurement cycles in order to acquire the measurement data for producing the image data.

A suitable measurement cycle may include the steps of:

(a) emitting electromagnetic radiation from a selected one of the emitter/receivers 120;

(b) producing measurement data representative of (i) the electromagnetic radiation emitted by the selected emitter/receiver 120 and (ii) electromagnetic radiation received by the non-selected emitter/receivers 120 after it has interacted with an object located in the imaging domain 130;

(c) selecting another emitter/receiver 120 and repeating steps (a) and (b) until each emitter/receiver 120 has been selected.

If the tomography apparatus has N emitter/receivers 120, then steps (a) and (b) will be repeated N times until each emitter/receiver 120 has been selected. For each repetition of steps (a) and (b), there will be M (=N−1) non-selected emitter/receivers 120 which receive electromagnetic radiation. Accordingly, the tomography apparatus can be viewed as having N emitters and M receivers at any one time.

The measurement data representative of electromagnetic radiation received by the non-selected emitter/receivers 120 may appropriately be stored in the form of a measurement matrix, e.g. a two-dimensional M×N measurement matrix. The measurement data representative of electromagnetic emitted by each of the selected emitter/receivers 120 is preferably used to normalise the measurement data representative of electromagnetic received by the non-selected emitter/receivers 120. This prevents the production of image data from being unduly influenced by any variation in the amount of electromagnetic radiation emitted by the selected emitter/receivers 120.

The measurement cycle may be repeated for K different frequencies of electromagnetic radiation, in which case the measurement data may appropriately be stored in the form of a measurement matrix, e.g. a three-dimensional M×N×K measurement matrix.

The measurement data in the measurement matrix may be in the form of complex numbers.

After a measurement cycle has been completed, the measurement data in the form of a measurement matrix may be communicated from the measuring means 150 to the processing means 160. The processing means 160 may then perform a step of producing image data representative of a dielectric and/or conductivity property distribution within the object located in the imaging domain 130 based on the measurement data.

If the processing means 160 is configured to produce multiple frames of image data, then image data may be in the form of video image data or static image data produced for each of the multiple frames. Preferably, the multiple frames of image data are produced in real-time.

FIG. 2 shows schematically a tomography apparatus 200 which may be used with the present invention.

The tomography apparatus 200 has a plurality of emitter/receivers 220 for emitting electromagnetic radiation and for receiving electromagnetic radiation from another one of the emitter/receivers 220. The plurality of emitter/receivers 220 are spatially distributed around an imaging domain 230. For illustrative purposes, the tomography apparatus 200 is shown with twenty-four emitter/receivers 220, but in practice, a larger or smaller number of emitter/receivers 220 may be provided as appropriate.

The tomography apparatus 200 may be viewed as having a plurality of electronic/microwave “Blocks” A to G.

Block A is a power supply unit for the tomography apparatus 200 and includes main power switches and fuses, certified medical grade isolation transformer (or transformers), AC-to-DC converter and cooling fans. The AC-to-DC converter and further power converters allow DC power to be supplied if necessary.

Block B is a computing unit including a computer and a networking hub.

Block C is a source of electromagnetic radiation operable to produce short pulses, e.g. a few nanoseconds in length, of microwaves.

Block D is a switching unit including a booster amplifier 241, a power divider 242, an attenuator 243, fast microwave switches with drivers, a power converter and a host controller.

Blocks E1 and E2 are further switching units, each including fast microwave switches with drivers, low-noise amplifiers, limiters and power converter. Block B controls Block C and the switches in Blocks D and E so that short pulses of microwaves produced by Block C are emitted by a selected emitter/receiver 220. Accordingly, Block B can be viewed as a control means for controlling the tomography apparatus 200 to emit electromagnetic radiation produced by the Block C from the emitter/receivers 220.

Block F is a multi-channel high speed vector signal digitizer for producing measurement data representative of the electromagnetic radiation incident on the emitter/receivers 220 when the apparatus is in use. Block F can be viewed as a measuring means for producing measurement data representative of the electromagnetic radiation incident on the emitter/receivers 220 after it has interacted with an object located in the imaging domain.

The power divider 242 in Block D is used split off a small and known proportion of electromagnetic radiation produced by Block C in order to allow the source of electromagnetic radiation to produce measurement data representative of electromagnetic radiation emitted by each of the emitter/receivers 220 when the apparatus is in use. Block C and the power divider 242 can therefore be seen as being part of a measuring means for producing measurement data representative of the electromagnetic radiation emitted by the emitter/receivers 220.

Block B processes the measurement data to produce image data representative of a dielectric and/or conductivity property distribution within an object located in the imaging domain 230. Accordingly, Block B can be viewed as a processing means for producing image data representative of a dielectric and/or conductivity property distribution within an object located in the imaging domain based on measurement data from Block F.

Block G is a physiological synchronization unit for allowing synchronization of the tomography apparatus 200 with the physiological activity of a biological object, e.g. human, to be imaged. The synchronisation may be achieved by way of a signal from Block G reflecting physiological activity of a subject to be imaged. For example, the signal may be indicative of the respiratory or cardiac condition of a human.

The time taken for the tomography apparatus 200 to complete each measurement cycle (described above with reference to FIG. 1) may be as low as 10-20 ms. This is an excellent time resolution and allows the tomography apparatus 200 to complete fifty to one hundred measurement cycles per second.

The object to be imaged may be a part of the human anatomy. If the tomography apparatus is able to complete each measurement cycle within 10-20 ms as described above, then the tomography apparatus 200 may be used to produce separate images at distinct phases of physiological activity of the human being imaged.

The physiological synchronization unit (Block G) may be used to synchronise the measurement cycles with physiological activity of a biological organism, e.g. a human. For example, the physiological synchronization unit may synchronise the measurement cycles so that at least some measurement cycles are performed during cardiac diastole or systole.

In one example, the measurement cycles are synchronised using the R-wave of an electrocardiogram (ECG) produced by the physiological synchronization unit (Block G). For example, there may be a predetermined time delays between the R-wave of an electrocardiogram and the initiation of measurement cycles in order that the measurement cycles take place during a desired phases of cardiac activity.

FIGS. 3a-c are respectively side, above and front views of a waveguide antenna 320 which may be used with the present invention. For example, the waveguide antenna 320 may be used as an emitter/receiver in the tomography apparatuses 100, 200 of FIGS. 1 and 2.

The waveguide antenna 320 may include a hole 321, which allows the waveguide antenna to be connected, via a coaxial cable 322, to a source of electromagnetic radiation and to a measuring means for producing measurement data representative of electromagnetic radiation received by the waveguide antenna 320.

The waveguide antenna 320 may have rectangular faces, and may have sides of length L₁, L₂, and L₃. All surfaces of the waveguide antenna 320 are coated by a metallisation layer 323 of any metal (but preferably a highly conductive metal such as silver), except the inside of the hole 321 and an emitting/receiving surface 324 at one end of the waveguide antenna 320. The metallisation layer 323 serves to guide electromagnetic waves along the waveguide antenna 320.

The emitting/receiving surface 324 of the waveguide antenna 320 is suitable for emitting and receiving electromagnetic radiation. It has a width L₂ and a height L₃. In this example, the coaxial cable 322 is coupled to the waveguide antenna 320 at a distance L₄ from an end opposite to the emitting/receiving surface 324 of the waveguide antenna 320.

In use, the emitting/receiving surface 324 of the waveguide antenna 320 faces the imaging domain of a tomography apparatus, e.g. a tomography apparatuses 100, 200 as shown in FIGS. 1 and 2.

Preferably, the waveguide antenna 320 has a complex permittivity whose real component matches, i.e. is substantially equal to, the real component of the complex permittivity of the object to be imaged and/or an interface medium (if present) so as to minimise the proportion of electromagnetic radiation that is reflected from the object to be imaged when the waveguide antenna 320 is used to emit electromagnetic radiation.

A first waveguide antenna of ceramic has dimensions L₁=53 mm, L₂=21 mm, L₃=7.5 mm and L₄=8.3 mm, a complex relative permittivity ∈ᵣ whose real component ∈ᵣ′ is approximately 50, and a complex permeability μᵣ whose real component μᵣ′ is 1. In use, the first waveguide antenna is able to emit/receive radiation having a frequency as low as 1 GHz in H₁₀ mode, because the emitting/receiving surface 324 has a width L₂ approximately equal to wₘᵢₙ (defined above), and therefore satisfies the equation:

$${L}_{2} \approx {w}_{min} = \frac{c}{2 {f}_{lower} \sqrt{{μ}_{r}^{′} {ɛ}_{r}^{′}}} = \frac{2.9979 \times {10}^{8}}{2 \times 1 \times {10}^{9} \sqrt{50}} = 0.021$$

The first waveguide antenna may be made by carrying out the following steps:

(i) sintering a powder of at least one ceramic precursor compound e.g. barium titanates (BaTi₄O₉ or Ba₂Ti₉O₂₀) to form a ceramic substrate including a hole and having dimensions L₁=53 mm, L₂=21 mm, L₃=7.5 mm and L₄=8.3 mm

(ii) metallising all surfaces of the ceramic substrate except for the emitting/receiving surface and the hole by applying a highly conductive layer (e.g. of silver) and sintering.

(iii) connecting the outer conductor of a coaxial cable with a metallised surface of the waveguide antenna, with the inner conductor of the coaxial cable extending into the ceramic substrate through the hole 321.

A second waveguide antenna of ceramic has dimensions L₁=1.7 mm, L₂=0.7 mm, L₃=0.2 mm and L₄=0.3 mm mm, a complex relative permittivity whose real component ∈ᵣ′ is approximately 50, and a complex permeability whose real component μᵣ′, which for illustrative purposes in this example, is approximately 1000. In use, the second waveguide antenna is able to emit/receive radiation as low as 1 GHz in H₁₀ mode, because the emitting/receiving surface has a width L₂ approximately equal to wₘᵢₙ (defined above), and therefore satisfies the equation:

$${L}_{2} \approx {w}_{min} = \frac{c}{2 {f}_{lower} \sqrt{{μ}_{r}^{′} {ɛ}_{r}^{′}}} = \frac{2.9979 \times {10}^{8}}{2 \times 1 \times {10}^{9} \sqrt{50 \times 1000}} = 0.07$$

Accordingly, the second waveguide antenna is able to emit and receive electromagnetic radiation having a frequency of as low as 1 GHz in H₁₀ mode, even though it is much smaller than the first waveguide antenna.

The second waveguide antenna may be made in the same way as the first waveguide antenna, except that step (i) includes mixing the at least one ceramic precursor compound with a ferrite material having a complex relative permeability whose real component μᵣ′ is more than 1. In this way, the real component of the complex relative permeability can be increased to a desired level.

Electromagnetic radiation having a frequency of around 1 GHz may be used with the waveguide antenna 320 of FIGS. 3a-c. At such frequencies, conventional ferrites (e.g. NiZn or MnZn) may not have a high permeability. However, this frequency region is of great interest for various industrial applications, e.g. wireless communications and data storage [Ref 2], and therefore there has been research into finding appropriate materials for ferrite materials exhibiting a high permeability at frequencies of around 1 GHz.

Suitable ferrite materials may be nanocrystalline Fe—Co—Ni—B based materials with an effective permeability of about 500 to 600 in the 1 GHz region [Ref 3]. Other suitable materials may be hexa-ferrites having the formula M(Fe₁₂O₁₉), where M is usually barium, strontium, calcium or lead [Ref 4].

FIG. 4 shows schematically the propagation of electromagnetic radiation (in a ray approximation) through an imaging chamber 470.

A cylindrical wall of the imaging chamber 470 defines an cylindrical imaging domain 430. A plurality of emitter/receivers are spatially distributed around the imaging domain 430. However, in FIG. 4 only two emitter/receivers 420a, 420b are illustrated for clarity. An object to be imaged 405, in this case biological tissue, is located in the imaging domain 430.

As explained previously, in conventional tomography apparatuses, the imaging domain is filled with an interface medium. However, in the imaging chamber 400 of FIG. 4, the imaging domain 430 is not filled with an interface medium. Instead, the imaging domain 430 is filled with air.

As shown in FIG. 4, electromagnetic radiation emitted from a first emitter/receiver 420a can take different paths to the second emitter/receiver 420b. Path A extends directly between the first emitter/receiver 420a and the second emitter/receiver 420b and passes through the object to be imaged. Accordingly, electromagnetic radiation following path A will interact with the object to be imaged 405 and therefore is useful for the production of image data representative of the dielectric and/or conductivity property distribution within the object to be imaged 405. Path B extends around the object to be imaged 405 and would be followed by electromagnetic radiation which reflects off the wall of the imaging chamber 470. Electromagnetic radiation following path B will not interact with the object to be imaged 405 and is therefore not useful for the production of image data representative of a dielectric and/or conductivity property distribution within the object to be imaged 405.

For the purposes of illustration, assume the imaging domain 430 has a diameter of 50 cm and the object to be imaged 405 has a length of 40 cm along path A. Accordingly, electromagnetic radiation following path A will travel 10 cm through the air-filled imaging domain and 40 cm through the object to be imaged. Electromagnetic radiation following path B will travel 70.7 cm (=2\sqrt{25²+25²}) through the air-filled imaging domain.

Assuming the air-filled imaging domain contains air, then the speed of propagation of electromagnetic radiation through the air-filled imaging domain will be approximately equal to the speed of light in free space, i.e. c=2.9979×10⁸ metres per second. The speed of light through the object to be imaged 405 will depend on the properties of the object to be imaged 405 and the frequency of electromagnetic radiation. Assuming that the object to be imaged 405 is human tissue having an average relative permittivity of about 50 at 1 GHz and about 72 at 0.1 GHz then the speed of propagation through the object to be imaged 405 will be approximately c/\sqrt{50}≈c/7 at frequencies of 1 GHz and c/\sqrt{50}≈c/8.5 at frequencies of 0.1 GHz.

Accordingly, the time period T_{A} taken for electromagnetic radiation to propagate along path A may be approximated as (length of path divided by speed along path)

$${T}_{A} = \frac{0.1}{c} + \frac{0.4}{( c / 7 )} = 9.7 ns$$

for electromagnetic radiation having a frequency of 1 GHz and

$${T}_{A} = \frac{0.1}{c} + \frac{0.4}{( c / 8.5 )} = 11.7 ns$$

for electromagnetic radiation having a frequency of 0.1 GHz.

In contrast, the time period T_{B} taken for electromagnetic radiation to propagate along path B may be approximated as (length of path divided by speed along path)

$${T}_{B} = \frac{0.707}{c} = 2.4 ns .$$

Accordingly, it can be seen that electromagnetic radiation emitted by the first emitter/receiver 420a which does not pass through the object to be imaged 405 arrives at the second emitter/receiver 420b much earlier than electromagnetic radiation emitted by the first emitter/receiver 420a which does pass through the object to be imaged 405.

FIG. 5 is illustrative of the electromagnetic radiation emitted and incident on the emitter/receivers 420a, 420b of FIG. 4 over time.

As shown in FIG. 5, the first emitter/receiver 420a emits electromagnetic radiation X over a short first time period t₁. Subsequently, electromagnetic radiation B is incident on the second emitter/receiver 420b, which is electromagnetic radiation from the first emitter/receiver 420a that has not passed through the object to be imaged 405 (e.g. by following path B in FIG. 4). Subsequently, electromagnetic radiation A is incident on the second emitter/receiver 420b, which is electromagnetic radiation from the first emitter/receiver 420a that has passed through the object to be imaged 405 (e.g. by following path A in FIG. 4).

Because the imaging domain 430 is filled with air, rather than an interface medium, a large proportion of electromagnetic radiation is reflected at the surface of the object to be imaged 405. Consequently, the amplitude of electromagnetic radiation received by the second emitter/receiver 420b which has not passed through the object to be imaged 405 is much larger than the amplitude of electromagnetic radiation which has passed through the object to be imaged 405. This is illustrated figuratively in FIG. 5, which shows the amplitude of electromagnetic radiation B being much larger than the amplitude of electromagnetic radiation A.

Preferably, a tomography apparatus is configured to make use of the difference in arrival times between electromagnetic radiation that has passed through the object to be imaged 405 (i.e. electromagnetic radiation A in FIG. 4) and the electromagnetic radiation that has not passed through the object to be imaged (i.e. electromagnetic radiation B in FIG. 4), so as to disregard the electromagnetic radiation that has not passed through the object to be imaged. This may be achieved by configuring the tomography apparatus so that electromagnetic radiation incident on the receivers during the second time period t₂ is disregarded for the production of image data when the apparatus is in use. For example, one of the tomography apparatuses 100, 200, 900 shown in FIGS. 1, 2 and 9 could be configured not to produce measurement data representative of electromagnetic radiation incident on the receivers during the second time period t₂.

Although FIG. 5 shows the electromagnetic radiation that has not passed through the object 405 as being received at a separate time from the electromagnetic radiation that has passed through the object 405, it is possible for some of electromagnetic radiation A to be received at the same time as some of electromagnetic radiation B.

FIGS. 6a and 6b show imaging chambers 632a, 632b which may be used with the present invention, e.g. in the tomography apparatuses 100, 200 of FIGS. 1 and 2.

Each imaging chamber 632a, 632b has a cylindrical wall 634a, 634b which defines a boundary of an imaging domain 630a, 630b, and a plurality of emitter/receivers 620a, 620b in the form of waveguide antennae which are spatially distributed around the imaging domain 630a, 630b. Waveguide antennae as shown in FIGS. 3a-c may be used for the waveguide antennae of FIGS. 6a and 6b.

The imaging chamber 632a of FIG. 6a is a 2D imaging chamber in which the emitter/receivers 620a are arranged in a single plane to define a planar imaging domain 630a. Accordingly, the emitter/receivers 620a of the imaging chamber 632a can be used to produce 2D image data representative of a dielectric property distribution within an object located in the planar imaging domain 630a. The emitter/receivers 620a are mounted on a movable sleeve 636a which allows the emitter/receivers 620a to be moved axially to a desired position along the imaging chamber 632a.

The imaging chamber 632b of FIG. 6b is a 3D imaging chamber in which the emitter/receivers 620b are arranged in several planes to define a 3D imaging domain 630b. Accordingly, the emitter/receivers 620b of the imaging chamber 632b can be used to produce 3D image data representative of a dielectric property distribution within an object located in the 3D imaging domain.

If the imaging chambers 632a, 632b of FIG. 6 are to be used for imaging human tissue, then the diameter of the imaging chambers 632a, 632b may be 40 to 50 cm, in order to accommodate a human chest or torso. As is conventional, the imaging chambers 632a, 632b of FIG. 6 are axially long, in order to minimise the proportion of electromagnetic radiation which reflects back into the imaging chamber from the boundaries at opposite axial ends of the cylindrical imaging chamber. In practice, this means that each imaging chamber 632a, 632b includes a portion, e.g. of length 10 cm, 15 cm or 20 cm, at either axial end in which emitter/receivers 620a, 620b are not located.

If the imaging chambers 632a, 632b of FIG. 6 are to be filled with an interface medium, then they may be provided with a wall at a lower axial end thereof, in order to keep the interface medium within the imaging domain 630a, 630b. Alternatively, if it is not intended for the imaging chambers 632a, 632b to be filled with an interface medium, then they may be left open at both axial ends or covered by anechoic material.

FIG. 7 shows an alternative imaging chamber 732 which may be used with the present invention.

As with the imaging chambers 632a, 632b of FIGS. 6a and 6b, the imaging chamber 732 of FIG. 7 has a cylindrical wall 734 which defines a boundary of an imaging domain 730, and a plurality of emitter/receivers 720 in the form of waveguide antennae which are spatially distributed around the imaging domain 730. Waveguide antennae as shown in FIGS. 3a-c may be used for the waveguide antennae of FIG. 7.

The imaging chamber 732 of FIG. 7 is lined by a lining 738 (marked in FIG. 7 by hatched lines) for reducing the amount of electromagnetic radiation which reflects from the wall 734 and onto the receivers when the apparatus is in use. The lining may therefore be referred to as being “anechoic”.

The lining 738 has a first portion 738a located at a first (upper) axial end of the imaging chamber 732 and a second portion 738b located at the other (lower) axial end of the imaging chamber 732. In this way, the lining 738 helps to reduce the proportion of electromagnetic radiation which reflects back into the imaging chamber from the boundaries at opposite axial ends of the cylindrical imaging chamber. This means that the axial length of the imaging chamber 732 can be significantly reduced (e.g. to about 5 cm) since, unlike the imaging chambers 632a, 632b of FIGS. 6a and 6b, there is no need for each axial end of the imaging chamber 732 to include a portion, e.g. of length 10 cm, 15 cm or 20 cm, in which emitter/receivers are not located.

Preferably, the lining 738 has an attenuation coefficient which is higher than that of human tissue at a frequency in the range 0.05 GHz to 10 GHz. The lining 738 may therefore include a lining material, preferably including a foam, into which an aqueous solution is absorbed. The aqueous solution may include one or more components selected from the group consisting of: one or more salts, fatty emulsion, sugar or glycerol. By varying the proportions of these one or more components, it is possible to increase the imaginary component ∈ᵣ″ of the complex relative permittivity, and therefore the attenuation coefficient, of the aqueous solution. In this way, the lining can be arranged to have an attenuation coefficient which is higher than that of human tissue at a frequency in the range 0.05 GHz to 10 GHz.

The lining 738 preferably has a complex relative permittivity ∈ᵣ whose real component ∈ᵣ′ is suitable for dielectrically matching the emitter/receivers 720 to an object to be imaged. This may be achieved by varying the components of the aqueous solution described above. A complex relative permittivity with a real component ∈ᵣ′=20-30 is preferable to achieve dielectric matching between the aqueous solution and human tissue.

As example values at 1 GHz and 23° C., the aqueous solution may have a complex relative permittivity with a real component ∈ᵣ′=77 and an imaginary component ∈ᵣ″=30, whereas water typically has a complex relative permittivity with a real component ∈ᵣ′=79 and an imaginary component ∈ᵣ″=4.5. In this case, the attenuation coefficient of the aqueous solution would be 0.36 cm⁻¹ compared with an attenuation coefficient of 0.054 cm⁻¹ for water.

FIG. 8 shows schematically another tomography apparatus 800 which may be used with the present invention.

The tomography apparatus 800 shown in FIG. 8 is similar to the tomography apparatus 200 shown in FIG. 2, with corresponding features having corresponding reference numerals. However, the tomography apparatus 800 of FIG. 8 has a new block C′ which is a multi-channel network analyser 810, to replace Blocks C and F from the tomography apparatus 200 of FIG. 2.

The vector network analyser 810 of Block C′ acts as a source of electromagnetic radiation and as a measuring means for producing measurement data representative of electromagnetic radiation received by the emitter/receivers 820 after it has interacted with an object located in the imaging domain.

A vector network analyser is a product used mainly in the telecommunications industry. Suitable vector network analysers for use in Block C′ include ZVA series vector network analysers available from Rohde & Schwartz® or PNA series network analysers available from Agilent Technologies.

FIGS. 9 and 10 show schematically further tomography apparatuses 900, 1000 which may be used with the present invention.

The tomography apparatuses 900, 1000 shown in FIGS. 9 and 10 are similar to the tomography apparatuses 200, 800 shown in FIGS. 2 and 8, with corresponding features having corresponding reference numerals. However, the tomography apparatuses 900, 1000 of FIGS. 9 and 10 have been modified to have emitter/receivers 920, 1020 that are independently movable with respect to each other, to allow the emitting/receiving surface of each emitter/receiver 920, 1020 to be independently applied to an object to be imaged.

In performing tomography, it is important that the relative position of all emitter/receivers is known in order to produce the image data. Accordingly, each emitter/receiver 920, 1020 in the tomography apparatuses 900, 1000 of FIGS. 9 and 10 is provided with a position determining means (not illustrated) for producing position data representative of the relative (3D) position and orientation of the emitter/receiver 920, 1020. The position determining means may form part of a local GPS-like system, an optical-based spatial positioning system or an ultrasound-based spatial positioning system, for example. The position data representative of the relative positions and orientations of the emitter/receivers 920, 1020 may be communicated to a processing means, e.g. via a host controller located in Block D, where it may be used in the production of the image data.

In addition to having the position determining means, each emitter/receiver 920, 1020 may also include an actuator 922, 1022 and a tissue contact sensor 924, 1024. Each tissue contact sensor 924, 1024 is for determining its emitter/receiver 920, 1020 is in contact with human tissue, e.g. by measuring the reflection of electromagnetic radiation emitted by its emitter/receiver 920, 1020 (a so-called S11 signal), as there is a big difference in the amount of electromagnetic radiation reflected depending on whether the emitter/receiver 920, 1020 contacts air or human tissue. Each actuator 922, 1022 is for adjusting the position of its emitter/receiver 920, 1020.

The position determining means, actuators 922, 1022 and tissue contact sensors 924, 1024 may communicate with, and be supplied with power from, a host controller located in Block D (see FIGS. 9 and 10).

In use for imaging human tissue, signals (including the position data) are communicated from the position determining means and the tissue contact sensors to the host controller located in Block D. The host controller then produces control signals to control the actuators 922, 1022 to move the emitter/receivers 920, 1020 in order to adjust the position of each emitter/receiver 920, 1020 so that it is in contact with the tissue of a human tissue.

Preferably, the tomography apparatuses 900, 1000 include a fluid medium (not shown) for providing an interface between the emitting/receiving surface of each emitter/receiver 920, 1020 and the object to be imaged. Preferably, the fluid medium has a complex relative permittivity whose real component is matched to, i.e. substantially equal to, the real component of the complex permittivity of the object to be imaged. Preferably, the fluid medium has an attenuation coefficient which is greater than that of the object to be imaged, to prevent leakage of electromagnetic radiation into the surrounding environment.

The fluid medium may be a gel including one or more components selected from the group consisting of: one or more salts, fatty emulsion, sugar or glycerol. By varying the proportions of these one or more components, it is possible to control the dielectric properties of the fluid medium.

FIG. 11 shows schematically another tomography apparatus 1100 which may be used with the present invention.

The tomography apparatus 1100 of FIG. 11 has an imaging chamber 1132 mounted to a base 1106 by a pair of arms 1108. The pair of arms 1108 are attached to the image chamber 1132 so that the image chamber 1132 can be rotated into any orientation with respect to the base 1106.

Preferably, the imaging chamber 1132 of the tomography apparatus 1100 of FIG. 11 is not filled with an interface medium and open at both ends, to make it easier to use in the clinical environment.

FIG. 12 is a block diagram illustrating a computer program for producing image data, which may be used with the present invention.

The computer program uses measurement data produced by a tomography apparatus (not shown), the measurement data being representative of electromagnetic radiation received by a plurality of receivers spatially distributed around an imaging domain of the tomography apparatus. In this example, the measurement data is produced by a measuring means of a tomography apparatus having N emitters and M receivers.

The tomography apparatus could be a tomography apparatus having N emitter/receivers, e.g. as shown in FIG. 1. During each measurement cycle, each of the N emitter/receivers will act as an emitter when selected, with the M (=N−1) non-selected emitter/receivers acting as a receiver at any one time.

In this example, the measurement data representative of electromagnetic radiation received by the receivers has been normalised using measurement data representative of electromagnetic radiation emitted by each of the emitters. Normalising the measurement data in this way prevents the production of image data from being unduly influenced by any variation in the amount of electromagnetic radiation emitted by the emitters.

In this example, the measurement data is complex, and is representative of the phase and amplitude of electromagnetic radiation received by the M receivers.

If the measurement data is produced using more than one frequency of electromagnetic radiation, then the measurement data may be provided in the form of a measurement matrix, e.g. a three-dimensional M×N×K measurement matrix, where K is the number of frequencies of electromagnetic radiation used to produce the measurement data.

If more than one frames of image data are to be produced, then L frames of measurement data may be produced. Where static image data is to be produced, L may be taken as 1.

In FIG. 12, the following notation is used:

i is the index of a receiver (varying between 1 and M).

j is an index of an emitter (varying between 1 and N).

k is an index of a frequency of electromagnetic radiation (varying between 1 and K), where K frequencies of electromagnetic radiation are used to produce the measurement data.

l is an index of a frame (varying between 1 and L), where L frames of measurement data are produced.

When executed, the computer program operates as follows.

A three-dimensional M×N×K experimental empty measurement matrix E^{EXP}(i,j,k) containing measurement data produced by the measuring means of the tomography apparatus when the imaging domain of the tomography apparatus is empty, is stored in a first data input module 1280a. L three-dimensional M×N×K experimental full measurement matrixes F^{EXP}(i,j,k), each containing measurement data produced by the measuring means of the tomography apparatus when an object to be imaged is located in the imaging domain of the tomography apparatus, are stored in a second data input module 1280b.

In this context, “empty” means that the imaging domain does not contain an object to be imaged, but may, for example, contain an interface medium. In this context, “full” means that the imaging domain does contain an object to be imaged.

A parameters module 1281 stores a plurality of parameters relating to the measurement data produced by the tomography apparatus. These parameters include the frequency f(k) of electromagnetic radiation used to produce the measurement data at each of the K frequencies, and an empty complex permittivity ∈_{empty}, which is the complex permittivity within the imaging domain when the imaging domain is empty, i.e. when no object to be imaged is located in the imaging domain. In this example, the empty complex permittivity ∈_{empty} is assumed to be constant.

The parameters from the parameters module 1281 are provided to an emitter/receiver model 1282, which uses the parameters to calculate theoretical values for the electromagnetic radiation emitted by the emitters and received by the receivers when the imaging domain is empty. These theoretical values are provided to a calibration module 1283, which uses these theoretical values to calculate a theoretical empty measurement matrix E^{THR}(i,j,k).

The calibration module 1283 determines an optimised value for the empty complex permittivity ∈_{empty} by comparing the experimental empty measurement matrix E^{EXP}(i,j,k) with a plurality of theoretical empty measurement matrixes E^{THR}(i,j,k) calculated using a plurality of trial values for the empty complex permittivity ∈_{empty}. For example, the empty complex permittivity ∈_{empty} may be determined as the trial value of the empty complex permittivity ∈_{empty} at which the average absolute difference between the experimental empty measurement matrix E^{EXP}(i,j,k) and the theoretical empty measurement matrix E^{THR}(i,j,k) is minimised.

In determining the optimised value for the empty complex permittivity ∈_{empty}, the trial values of empty complex permittivity ∈_{empty} may be calculated according to ∈_{empty}±Δ, where Δ is a search interval. The search interval Δ, for example, could be 1%, 5% or 10% (or other percentage, preferably less than 100%) of a previous or initial value of the empty complex permittivity ∈_{empty}. It could be a constant.

Calculating an optimised value for the empty complex permittivity ∈_{empty} helps to improve the quality of the image data that can be produced by the computer program.

The calibration module 1283 calculates a calibration matrix C(i,j,k) using the experimental empty measurement matrix E^{EXP}(i,j,k) and parameters from the parameters module 1281, including the frequency f(k) of electromagnetic radiation used to produce the measurement data at each of the K frequencies, and the empty complex permittivity ∈_{empty} (which has preferably been optimised as described above).

A scattered fields calculation module 1285 calculates L experimental scattered field matrixes S^{EXP}(i,j,k) containing complex data representative of the electromagnetic fields scattered by an object located in the imaging domain. The L experimental scattered field matrixes S^{EXP}(i,j,k) are calculated using the experimental empty measurement matrix E^{EXP}(i,j,k), the L experimental full measurement matrixes F^{EXP}(i,j,k), the calibration matrix C(i,j,k) and the frequency f(k) of electromagnetic radiation used to produce the measurement data at each of the K frequencies. The frequency f(k) of electromagnetic radiation used to produce the measurement data at each of the K frequencies is stored in a control module 1286.

The L experimental scattered field matrixes S^{EXP}(i,j,k) from the scattered fields calculation module 1285 are fed through a geometry adjustment module 1287 to a difference calculation module 1288.

If the tomography apparatus uses independently movable emitters and/or receivers, e.g. as described with reference to FIGS. 9 and 10, then the computer program may include a first domain geometry input module 1289a which stores position data representative of the relative positions of the emitters and/or receivers from a position determining means. In the geometry adjustment module 1287, this position data is used to adjust the L experimental scattered fields matrixes S^{EXP}(i,j,k), so as to take account of the relative positions of the independently movable emitters and/or receivers. Thus, the position data is used in the production of the L experimental scattered fields matrixes S^{EXP}(i,j,k) so as to take account of the relative positions of the independently movable emitters and/or receivers.

Data from the parameters module 1281, one of the domain geometry modules 1289a, 1289b (if present), and the frequency control module 1286 is provided to a direct problem solver module 1290. In the direct problem solver module 1290, the distribution of the electromagnetic field from each of the N emitters into each of the M receivers is calculated (using known methods) at a first one of the K frequencies using a three-dimensional distribution of complex permittivity ∈(x,y,z) to produce a theoretical scattered field matrix S^{THR}(i,j,k) containing complex data representative of the electromagnetic fields scattered by an object to be imaged located in the imaging domain. The theoretical scattered field matrix S^{THR}(i,j,k) is the solution of the so-called “direct problem”.

If the tomography apparatus uses independently movable emitters and/or receivers, e.g. as described with reference to FIGS. 9 and 10, then the computer program may include a second domain geometry input module 1289b which stores position data representative of the relative positions of the emitters and/or receivers from a position determining means. In the direct problem solver 1290, this position data is used in the production of the theoretical scattered fields matrix S^{THR}(i,j,k), so as to take account of the relative positions of the independently movable emitters and/or receivers.

For the first iteration, the three-dimensional distribution of complex permittivity ∈(x,y,z) used by the direct problem solver module 1288 may be taken as being homogeneous, e.g. ∈(x,y,z)=∈_{empty}. On subsequent iterations, the three-dimensional distribution of complex permittivity ∈(x,y,z) is preferably taken from a previous iteration. See below for details.

A difference calculation module 1291 calculates the difference between the theoretical and experimental scattered field matrixes, i.e. S^{THR}(i,j,k)−S^{EXP}(i,j,k), for each i, j. This complex matrix data is then fed through an inverse solver switch 1292 which is operable to switch between three inverse solver modules 1293a, 1293b, 1293c. Each inverse solver module contains a different respective algorithm for calculating (or “reconstructing”) a three-dimensional distribution of complex permittivity ∈(x,y,z) by inverting the scattered field matrixes. Known algorithms for calculating (or “reconstructing”) a three-dimensional distribution of complex permittivity ∈(x,y,z) include, Born, Rytov, Newton, and Gradient.

In the selected inverse solver module 1293a, 1293b or 1293c, the scattered field matrix data is inverted to calculate (or “reconstruct”) a three-dimensional distribution of complex permittivity ∈(x,y,z) representative of an object located in the imaging domain. The residual error, which is the sum of the absolute difference between the theoretical and experimental scattered field matrixes for all i, j (i.e. the sum of |S^{THR}(i,j,k)−S^{EXP}(i,j,k)| for all i, j) is then compared with a pre-defined threshold in an error assessment module 1294. This completes a first iteration.

If the error assessment module 1294 determines that the residual error is more than the pre-defined threshold, then the three-dimensional distribution of complex permittivity ∈(x,y,z) is fed back into the direct problem solver module 1290 for a further iteration. Iterations are performed until the residual error is less than or equal to the pre-determined threshold, with the three-dimensional distribution of complex permittivity ∈(x,y,z) obtained in a p−1^{th} iteration being used for the p^{th} iteration.

The inverse solver switch 1292 may be configured to switch between the inverse solver modules 1293a, 1293b, 1293c according to the number p of iterations that have been performed. For example, the inverse solver switch may select the first inverse solver module 1293a if p≦A, the second inverse solver module 1293b if A<p≦B, and the third inverse solver module 1293c if p>B. Appropriate choice of values for A and B could then lead to an improvement in the quality of the image data produced by the computer program.

Where measurement data has been produced for more than one frequency, i.e. where K is greater than 1, a multiple frequency module 1295 determines whether there are any frequencies for which a three-dimensional distribution of complex permittivity ∈(x,y,z) has not been calculated. If so, then the multiple frequency module 1295 instructs the computer program to repeat the above-described process for a next one of the K frequencies, so as to calculate a three-dimensional distribution of complex permittivity ∈(x,y,z) for that frequency. This is repeated until a three-dimensional distribution of complex permittivity ∈(x,y,z) has been calculated for all K frequencies.

The initial three-dimensional distribution of complex permittivity ∈(x,y,z) used to calculate the three-dimensional distribution of complex permittivity ∈(x,y,z) for a k^{th} frequency might be (i) a three-dimensional distribution of complex permittivity ∈(x,y,z) calculated for a previous, e.g. k−1^{th} frequency; (ii) a homogeneous distribution, e.g. ∈(x,y,z)=∈_{empty}; or (iii) a weighted three-dimensional distribution of complex permittivity ∈(x,y,z) based on three-dimensional distributions of complex permittivity ∈(x,y,z) that have been calculated for a plurality of previous frequencies.

It is well known that the dielectric properties of biological tissues have frequency dispersion, i.e. that the three-dimensional distributions of complex permittivity ∈(x,y,z) for biological tissues vary as a function of frequency. If the frequency range of the K frequencies used by the tomography apparatus is large, then a tissue dispersion correction module 1296 may be used to correct the three-dimensional distribution of complex permittivity ∈(x,y,z) calculated for a k−1^{th} frequency before it is used as the initial three-dimensional distribution of complex permittivity ∈(x,y,z) to calculate the three-dimensional distribution of complex permittivity ∈(x,y,z) for a subsequent k^{th} frequency. If the frequency range of the K frequencies used by the tomography apparatus is small, then the tissue dispersion correction module 1296 may be omitted.

If the computer program is used to produce a static image, i.e. where L is 1, then the calculated three-dimensional distribution of complex permittivity ∈(x,y,z) are post-processed by a single-frame image post-processing module 1297 to produce “static” image data representative of the complex permittivity distribution within the object located in the imaging domain (e.g. representative of the three-dimensional distribution of complex permittivity ∈(x,y,z) within the object located in the imaging domain) based on the three-dimensional distribution of complex permittivity ∈(x,y,z) calculated for the single frame of image data.

Where measurement data has been produced for more than one frame of image data, i.e. where L is greater than 1, the multiple frame module 1298 determines whether there are any frames for which a three-dimensional distribution of complex permittivity ∈(x,y,z) has not been calculated. If so, then the multiple frame module 1298 instructs the computer program to repeat the above-described process for a next one of the L frames, so as to calculate a three-dimensional distribution of complex permittivity ∈(x,y,z) for that frame. This is repeated until a three-dimensional distribution of complex permittivity ∈(x,y,z) has been calculated for all L frames.

The initial three-dimensional distribution of complex permittivity ∈(x,y,z) used by the direct problem solver module 1290 used to calculate the three-dimensional distribution of complex permittivity ∈(x,y,z) for an l^{th} frame might be (i) a three-dimensional distribution of complex permittivity ∈(x,y,z) calculated for a previous, l−1^{th}, frame; (ii) a homogeneous distribution, e.g. ∈(x,y,z)=∈_{empty}; or (iii) a weighted three-dimensional distribution of complex permittivity ∈(x,y,z) based on three-dimensional distributions of complex permittivity ∈(x,y,z) that have been calculated for a plurality of previous frames. In cases (i) and (ii), the previously obtained three-dimensional distribution of complex permittivity ∈(x,y,z) may be corrected for movement artefacts within a movement correction module 1298a.

Once a three-dimensional distribution of complex permittivity ∈(x,y,z) has been calculated for all L frames, a multiple frame image post-processing module 1299 post-processes the three-dimensional distribution of complex permittivity ∈(x,y,z) calculated for each of the L frames, to produce a plurality of frames of image data, each frame being representative of the complex permittivity distribution within the object located in the imaging domain (e.g. representative of the three-dimensional distribution of complex permittivity ∈(x,y,z) within the object located in the imaging domain) at a different time, based on the three-dimensional distributions of complex permittivity ∈(x,y,z) calculated for each of the L frames. The image data produced may be in the form of video image data or static image data produced for each of the L frames. The post-processing unit may be configured to display the image data it produces on a display.

The multiple frame post-processing module preferably includes an “absolute imaging” module 1299a and a “differential imaging” module 1299b for producing the image data, which may be used to produce image data individually or at the same time.

The absolute imaging module 1299a is preferably configured to produce image data that includes values representative of the “absolute” complex permittivity distribution within the object located in the imaging domain, i.e. values representative of the actual complex permittivity distribution within the object. Such values may be produced, for example, by extracting values contained within the three-dimensional distribution of complex permittivity ∈(x,y,z) calculated for each of the L frames.

The differential imaging module 1299b is preferably configured to produce image data that includes values representative of the change, if any, in the complex permittivity distribution within the object located in the imaging domain over time. For example, the values may be representative of the difference, if any, between the complex permittivity distribution within the object located in the imaging domain at two (or more) different times. Such values of complex permittivity may produced, for example, by subtracting the three-dimensional distribution of complex permittivity ∈(x,y,z) calculated for a first of the L frames of image data, from the three-dimensional distribution of complex permittivity ∈(x,y,z) calculated for a second of the L frames of image data.

In this way, the image data produced by the multiple frame image post-processing module 1299 may be representative either of absolute values of complex permittivity or of relative values of complex permittivity (i.e. showing the relative differences in complex permittivity between the L frames of image data). The post-processing unit may be configured to display the image data produced by the absolute imaging module and/or the differential imaging module on a display.

Although the above described computer program is used to calculate a three-dimensional distribution of complex permittivity ∈(x,y,z), it would equally be possible for the computer program to calculate a two-dimensional distribution of complex permittivity, e.g. ∈(x,y). This may be particularly applicable if the tomography apparatus has a 2D imaging chamber.

The frequencies of electromagnetic radiation with which the invention may be used for clinical imaging shall now be discussed.

Tomography, in its classical sense, involves irradiation of an object to be imaged from a plurality of sources of electromagnetic radiation, preferably from a plurality of three dimensional angles. This suggests that the complex permittivity of an object to be imaged does not depend on a direction of electromagnetic radiation incident on the object to be imaged.

A study [Ref 5] using simulations to investigate the anisotropy of myocardial tissue found that a lower boundary for frequencies of electromagnetic radiation that could be used by a tomography apparatuses is within 0.05 to 0.1 GHz (50 to 100 MHz). At frequencies lower than this, the anisotropy within the tissue becomes very large and therefore has a negative effect on the quality of the resulting image. Therefore, a lower boundary frequency of electromagnetic radiation for clinical (human) imaging may be 0.05 GHz or 0.1 GHz.

An upper boundary for frequencies of electromagnetic radiation that could be used by a tomography apparatuses to investigate the dielectric properties of an object may be determined by the high attenuation of electromagnetic radiation within biological tissue at high frequencies.

Another study [Ref 6, 7] which considered the technical performance of high-end microwave and electronic components found that, to obtain a signal-to-noise-ratio of about 30 dB and a temporal resolution within the millisecond range, an upper boundary frequency of electromagnetic radiation that could be used by a tomography apparatus may be about 1.5 GHz for large biological objects (e.g. a human torso) and may be as high as 6 GHz or 10 GHz for smaller biological objects (e.g. a breast or an extremity of a human subject). Therefore, an upper boundary frequency of electromagnetic radiation for clinical (human) imaging may be 1.5 GHz, 6 GHz or 10 GHz.

For clinical (human) imaging, a goal is to have a tomography apparatus that is useful for non-invasive assessment of the functional and pathological conditions of target biological tissue. To this end, it is desirable to have a tomography apparatus that provides good sensitivity, good specificity, good temporal resolution and good spatial resolution. Based on a far electromagnetic field assumption, the best spatial resolution can be achieved at high frequencies. However, attenuation of electromagnetic radiation in biological media is inversely dependent on frequency. Consequently, the signal-to-noise ratio decreases at high frequencies. Accordingly, it is desirable to find the highest frequency at which receivers will still be able to detect a signal with reliable signal-to-noise ratio and will not compromise temporal resolution. It is to be emphasised, however, that there is potential to improve spatial resolution in the near electromagnetic field using non-linear inversion [Ref 8, 9].

It has been shown that the dielectric properties of biological tissues are a sensitive indicative of their physiological and pathological conditions, such as tissue blood content, hypoxia, ischemia, infarction, and malignancies [Ref 10, 11]. The dielectric changes relating to those physiological and pathological conditions are frequency, dependent. Therefore sensitivity to physiological and pathological conditions is another parameter for frequency optimisation.

Accordingly, it can be seen that a preferable range of frequencies of electromagnetic radiation for clinical imaging depends on the object/tissue under study. Based on experimental and simulation studies, possible ranges of frequencies for different applications are indicated in the following table:

| | Frequency range |
|---|---|
| Clinical Application | [GHz] |
| 1. Cardiac imaging | 0.5-1.5 GHz |
| 2. Lung cancer detection | 0.5-1.5 GHz |
| 3. Brain imaging | 0.5-4.0 GHz |
| 4. Breast imaging | 0.5-4.0 GHz |
| 5. Extremities imaging | 0.5-4.0 GHz |

One of ordinary skill after reading the foregoing description will be able to affect various changes, alterations, and subtractions of equivalents without departing from the broad concepts disclosed. It is therefore intended that the scope of the patent granted hereon be limited only by the appended claims, as interpreted with reference to the description and drawings, and not by limitation of the embodiments described herein.

For example, although many of the tomography apparatuses described herein include a plurality of emitter/receivers, it would be possible for the apparatus to include separately provided emitters and receivers.

As another example, although some embodiments described in connection with microwaves, electromagnetic radiation having other frequencies in the range 0.05 GHz to 10 GHz could also be used.

### REFERENCES

1. J. D. Jackson “Classical Electrodynamics”, 3^{rd} edition, John Wiley & Sons, Inc, 1999.
2. “Handbook of advanced magnetic materials (v1, v2): nanostructure effects, characterization and simulation”, edited by L Yi, D J Sellmyer and D Shindo, Kluwer Academic Publishers group, Springer, 2005.
3. J Shim, J Kim, S H Han, H J Kim, Ki Hyeon Kim and M Yamagushi “Nanocrystalline Fe—Co—Ni—B thin film with high permeability and high-frequency characteristics”, J of Magnetism and Magnetic Materials, 2005, 290-291, 205-208.
4. S B Narang and I S Hudiara “Microwave dielectric properties of M-Type barium, calcium and strontium hexa-ferrite substituted with Co and Ti”, J of Ceramic Proc Res, 2006, 7, 2, 113-116.
5. Semenov S. Y., Svenson R. H., Simonova G., Bulyshev A. E., Souvorov A. E., Sizov Y. E., Nazarov A. G., Pavlovsky A. V., Tatsis G. P., Taran M., Starostin A. N. “A model of myocardial dielectric properties in the frequency spectrum from 0.2 MHz up to 6.0 GHz. Application to myocardial anisotropy, acute and chronic myocardial infarction study”, in Proceedings of the X International Conference on Electrical Bio-Impedance, April 5-9, 1998, Barcelona, Spain, 155-158.
6. Semenov S. Y., Svenson R. H., Bulyshev A. E., Souvorov A. E., Nazarov A. G., Sizov Y. E., Pavlovsky A., Borisov V. Y., Voinov B. G., Simonova G., Starostin A. N., Tatsis G. P., Baranov V. Y., “Three dimensional microwave tomography. Experimental prototype of the system and vector Born reconstruction method”, IEEE Trans. BME, 1999, 46, 8, 937-946.
7. Semenov S. Y., Svenson R. H., Boulyshev A. E., Souvorov A. E., Nazarov A. G., Sizov Y. E., Posukh V. G., Pavlovsky A., Repin P. N., Starostin A. N., Voinov B., Tatsis G. P., Baranov V. Y. “Three-dimensional microwave tomography: initial experimental imaging of animals”, IEEE Trans BME, 2002, 49, 1, 55-63.
8. F. C. Chen, W. C. Chew “Experimental verification of super resolution in nonlinear inverse scattering”, Applied Physics Letters, 1998, 72, 23, 3080-3082.
9. P. M. Meaney, K. D. Paulsen, A. Hartov, R. C. Crane “Microwave imaging for tissue assessment: initial evaluation in multitarget tissue-equivalent phantoms”, IEEE Trans BME, 1996, 43, 9, 878-890.
10. Semenov S. Y., Svenson R. H., Tatsis G. P. “Microwave spectroscopy of myocardial ischemia and infarction. 1. Experimental Study”, Annals of Biomedical Engineering, 2000, 28, 1, 48-54.
11. Semenov S. Y., Svenson R. H., Posukh V. G., Chen W., Nazarov A. G., Sizov Y. E., Kassel J., Tatsis G. P. “Dielectrical spectroscopy of canine myocardium during ischemia and hypoxia at frequency spectrum from 100 KHz to 6 GHz”, IEEE Trans MI, 2002, 21, 6, 703-707.
12. Devaney A. J. “Current research topics in diffraction tomography”, in Inverse Problems in Scattering and Imaging, M. BNertero and E. R. Pike, Eds, New York: Adam Hilger, 1992, pp. 47-58.
13. A. E. Souvorov, A. E. Bulyshev, S. Y. Semenov, R. H. Svenson, A. G. Nazarov, Y. E. Sizov, and G. P. Tatsis, “Microwave tomography: A two-dimensional Newton iterative scheme”, IEEE Trans. Microwave Theory and Techniques, vol. 46, pp. 1654-1659, November 1998.
14. R. E. Kleinman, and P. M. van den Berg, “A modified gradient method for two-dimensional problems in tomography”, J. Comput. Appl. Math., vol. 42, pp. 17-35, January 1992.
15. A. E. Bulyshev, A. E. Souvorov, S. Y. Semenov, R. H. Svenson, A. G. Nazarov, Y. E. Sizov, and G. P. Tatsis, “Three-dimensional microwave tomography. Theory and computer experiments in scalar approximation”, Inverse Problems, vol. 16, pp. 863-875, June 2000.
16. A. Abubakar, P. M. van den Berg, and J. J. Mallorqui, “Imaging of Biomedical Data Using A Multiplicative Regularized Source Inversion Method,” IEEE Trans. Microwave Theory and Techniques, v. 50, pp. 1761-1771, July 2002.
17. N. Joachimowicz, J. J. Mallorqui, J. Ch. Bolomey, and A. Brouguetas, “Convergence and stability assessment of Newton-Kantorovich reconstruction algorithms for microwave tomography”, IEEE Trans. Medical Imaging, vol. 17, pp. 562-570, August 1998.
18. P. Lobel, R. Kleinman, Ch. Pichot, L. Blanc-F•raud, and M. Barlaud “Conjugate Gradient Method for Solving Inverse Scattering with Experimental Data”, IEEE Antennas & Propagation Magazine, Vol. 38, pp. 48-51, June 1996
19. W. C. Chew, and Y. M. Wang, “Reconstruction of two-dimensional permittivity distribution using the distorted Born iterative method”, IEEE Trans. Medical Imaging, vol. 9, p. 218-225, Jun. 1990.
20. H. Harada, D. Wall, T. Takenaka, and T. Tanaka, “Conjugate gradient method applied to inverse scattering problem”, IEEE Trans. Antennas and Propag'tions, vol. 43, 784-792, March 1995.
21. P. M. Meaney, K. D. Paulsen, A. Hartov, and R. K. Crane, “Microwave imaging for tissue assessment: Initial evaluation in multitarget tissue equivalent phantoms”, IEEE Trans. Biomedical Engineering, vol. 43, pp. 878-890, September 1996.
22. Semenov S. Y., Bulyshev A. E., Abubakar A., Posukh V. G., Sizov Y. E., Souvorov A. E., Van den Berg P., Williams T. “Microwave tomographic imaging of the high dielectric contrast objects using different imaging approaches”, IEEE Trans. MTT, v. 53, No 7, pp 2284-2294, 2005.
23. Bulyshev A. E, Souvorov A. E., Semenov S. Y., Posukh V. G., Sizov Y. E. “Three-dimensional Vector Microwave Tomography. Theory and Computational experiments”, Inverse Problems, 2004, 20, 4, 1239-1259.

1. A tomography apparatus for producing image data representative of a dielectric and/or conductivity property distribution within an object using electromagnetic radiation having a frequency in the range 0.05 GHz to 10 GHz, the apparatus having:
a plurality of emitters for emitting electromagnetic radiation having a frequency in the range 0.05 GHz to 10 GHz, the emitters being spatially distributed around an imaging domain;
a plurality of receivers spatially distributed around the imaging domain for receiving electromagnetic radiation;
a control means for controlling the apparatus to emit electromagnetic radiation from each of the emitters;
a measuring means for producing measurement data representative of electromagnetic radiation received by the receivers after it has interacted with an object located in the imaging domain; and
a processing means for producing image data representative of a dielectric and/or conductivity property distribution within an object located in the imaging domain based on measurement data from the measuring means;
wherein the tomography apparatus is configured so that electromagnetic radiation incident on the receivers during a second time period t₂ is disregarded for the production of said image data when the apparatus is in use, the second time period t₂ being subsequent to a first time period t₁ during which electromagnetic radiation is emitted by a selected one of the emitters; and
wherein the duration of the second time period t₂ is set such that the electromagnetic radiation that is disregarded includes at least some electromagnetic radiation emitted by the selected emitter which is incident on the receivers and which has not passed through an object to be imaged.

2. The tomography apparatus according to claim 1 wherein:
the duration of the time period t₂ is set such that the electromagnetic radiation that is disregarded includes substantially all the electromagnetic radiation emitted by the selected emitter which is incident on the receivers and which has not passed through an object to be imaged; or
the duration of the time period t₂ is set to be greater than a time taken for electromagnetic radiation to travel from the selected emitter to a receiver on an opposite side of the imaging domain without passing through the object to be imaged.

3. (canceled)

4. The tomography apparatus according to claim 1 wherein the duration of the second time period t₂ is set to be 1 ns or more, 2 ns or more, 5 ns or more, or 10 ns or more.

5. The tomography apparatus according to claim 1 wherein:
the durations of the first and second time periods t₁, t₂ are set such that the duration of the combined time period t₁+t₂ is such that the electromagnetic radiation that is disregarded includes substantially none of the electromagnetic radiation from the selected emitter which is incident on the receivers and which has passed through the object to be imaged; or
the durations of the first and second time periods t₁, t₂ are set such that the duration of the combined period t₁+t₂ is substantially equal to or less than a time taken for electromagnetic radiation to travel from the selected emitter to a receiver on an opposite side of the imaging domain whilst passing through the object to be imaged.

6-7. (canceled)

8. The tomography apparatus according to claim 1 wherein the tomography apparatus is configured so that electromagnetic radiation that is incident on the receivers during a third time period t₃ subsequent to the second time period t₂ is used for the production of said image data when the apparatus is in use, the durations of the first, second and third time periods t₁,t₂,t₃ being set such that the electromagnetic radiation that is used for the production of image data includes at least some of the electromagnetic radiation emitted by the selected emitter which is incident on the receivers and which has passed through the object to be imaged.

9. The tomography apparatus according to claim 1 wherein:
the duration of first time period t₁ is set to be equal to or less than a time taken for electromagnetic radiation to travel from the selected emitter to a receiver on an opposite side of the imaging domain whilst passing through the object to be imaged; or
the duration of the first time period t₁ is 5 ns or less, 2 ns or less, or 1 ns or less.

10-11. (canceled)

12. A method of producing image data representative of a dielectric and/or conductivity property distribution within an object using electromagnetic radiation having a frequency in the range 0.05 GHz to 10 GHz, the method including:
emitting electromagnetic radiation having a frequency in the range 0.05 GHz to 10 GHz from a selected one of a plurality of emitters, the emitters being spatially distributed around an imaging domain in which the object is located;
producing measurement data representative of electromagnetic radiation received by a plurality of receivers after it has interacted with the object located in the imaging domain, the plurality of receivers being spatially distributed around the imaging domain; and
producing image data representative of a dielectric and/or conductivity property distribution within an object located in the imaging domain based on the measurement data;
wherein the electromagnetic radiation incident on the receivers during a second time period t₂ is disregarded for the production of said image data, the second time period t₂ being subsequent to a first time period t₁ during which the electromagnetic radiation is emitted by the selected emitter; and
wherein the duration of the second time period t₂ is set such that the electromagnetic radiation that is disregarded includes at least some electromagnetic radiation emitted by the selected emitter which is incident on the receivers and which has not passed through an object to be imaged.

13-60. (canceled)

61. The tomography apparatus according to claim 1 wherein:
the tomography apparatus includes a plurality of waveguide antennae which each act as a respective one of the emitters and/or receivers; and
the real component μᵣ′ of the complex relative permeability μᵣ of each waveguide antenna is substantially more than 1, and, optionally, wherein each waveguide antenna has an emitting and/or receiving surface facing the imaging domain, the emitting and/or receiving surface having a width w which satisfies the inequality: w≧c/2f_{lower}\sqrt{μᵣ′∈ᵣ′}, where c is the speed of light in free space in metres per second, f_{lower} is an lower boundary frequency of electromagnetic radiation in Hz, μᵣ′ is the real component of the complex relative permeability of the waveguide antenna, and ∈ᵣ′ is the real component of the complex relative permittivity of the waveguide antenna.

62. The tomography apparatus according to claim 1 wherein the apparatus includes an imaging chamber having one or more walls which define a boundary of the imaging domain, said one or more walls of the imaging chamber being lined by a lining for reducing the amount of electromagnetic radiation which reflects from the walls and onto the receivers when the apparatus is in use.

63. The tomography apparatus according to claim 1 wherein the tomography apparatus includes a source of electromagnetic radiation coupled to all of the emitters by a first coupling means so that electromagnetic radiation produced by the source can be coupled to any one of the emitters; and
wherein the source also acts as the measuring means and is coupled to all of the receivers by a second coupling means so that it can produce measurement data representative of the amplitude and phase of electromagnetic radiation incident on the receivers.

64. The tomography apparatus according to claim 1 wherein the emitters and/or receivers are independently movable with respect to each other, to allow an emitting and/or receiving surface of each emitter and/or receiver to be independently applied to an object to be imaged.

65. The tomography apparatus according to claim 1 wherein the apparatus is configured to use a computer program that produces the image data by calculating electromagnetic fields between individual pairs of emitters and receivers.

66. The tomography apparatus according to claim 1 wherein the durations of the first and second time periods t₁, t₂ may be set such that the duration of the combined time period t₁+t₂ is substantially equal to or less than 20 ns, 15 ns, 10 ns or 5 ns.

67. The tomography apparatus according to claim 1 wherein the measuring means is configured not to produce measurement data representative of electromagnetic radiation incident on the receivers during the second time period t₂.

68. The tomography apparatus according to claim 1 wherein the control means is arranged to control the apparatus according to a plurality of measurement cycles, each measurement cycle including the steps of:
(a) emitting electromagnetic radiation from a selected one of the emitters;
(b) producing measurement data representative of (i) electromagnetic radiation emitted by the selected emitter and (ii) electromagnetic radiation received by the receivers after it has interacted with an object located in the imaging domain;
(c) selecting another emitter and repeating steps (a) and (b) until each emitter has been selected;
wherein the control means is arranged to control the apparatus such that each measurement cycle is followed by a further step of;
(d) producing image data representative of a complex permittivity distribution within the object located in the imaging domain based on the measurement data.

69. The method according to claim 12 wherein the method includes the further step of selecting another emitter and repeating the steps of emitting electromagnetic radiation and producing measurement data until each emitter has been selected.

70. The method according to claim 12 wherein an imaging chamber has one or more walls which define a boundary of the imaging domain, and the imaging chamber is not filled with an interface medium during the method.

71. The method according to claim 12 wherein the method includes any one or more of the following steps:
(a) determining an optimised value for the complex permittivity within the imaging domain when the imaging domain is empty by comparing experimental measurement data from the tomography apparatus with theoretical measurement data calculated using a plurality of trial values for the permittivity of the imaging domain when the imaging domain is empty;
(b) using position data representative of the relative positions of a plurality of independently movable emitters and/or receivers of the tomography apparatus in the production of experimental data representative of the electromagnetic fields scattered by an object located in the imaging domain;
(c) using position data representative of the relative positions of a plurality of independently movable emitters and/or receivers of the tomography apparatus in the production of theoretical data representative of the electromagnetic fields scattered by an object located in the imaging domain;
(d) switching between using a first algorithm for reconstructing a distribution of complex permittivity, a second algorithm for reconstructing a distribution of complex permittivity and, optionally, a third algorithm for reconstructing a distribution of complex permittivity;
(e) calculating a plurality of distributions of complex permittivity, each distribution of complex permittivity being calculated using measurement data that has been produced using a respective frequency of electromagnetic radiation;
(f) calculating a plurality of distributions of complex permittivity, each distribution of complex permittivity being calculated using measurement data that has been produced for a respective frame of image data; and
(g) producing image data representative of a complex permittivity distribution within an object located in the imaging domain, wherein the image data includes values representative of the change, if any, in the complex permittivity distribution within the object located in the imaging domain over time.

72. A non-transitory computer readable medium on which a computer program executable on a computer is stored wherein the computer program comprises instructions for a method of producing image data representative of a dielectric and/or conductivity property distribution within an object using electromagnetic radiation having a frequency in the range 0.05 GHz to 10 GHz, the method including:
emitting electromagnetic radiation having a frequency in the range 0.05 GHz to 10 GHz from a selected one of a plurality of emitters, the emitters being spatially distributed around an imaging domain in which the object is located;
producing measurement data representative of electromagnetic radiation received by a plurality of receivers after it has interacted with the object located in the imaging domain, the plurality of receivers being spatially distributed around the imaging domain; and
producing image data representative of a dielectric and/or conductivity property distribution within an object located in the imaging domain based on the measurement data;
wherein the electromagnetic radiation incident on the receivers during a second time period t₂ is disregarded for the production of said image data, the second time period t₂ being subsequent to a first time period t₁ during which the electromagnetic radiation is emitted by the selected emitter; and
wherein the duration of the second time period t₂ is set such that the electromagnetic radiation that is disregarded includes at least some electromagnetic radiation emitted by the selected emitter which is incident on the receivers and which has not passed through an object to be imaged.

73. The tomography apparatus of claim 1 wherein the tomography apparatus is configured so that electromagnetic radiation incident on the receivers during a second time period t₂ is disregarded for the production of said image data when the apparatus is in use, the second time period t₂ being subsequent to a first time period t₁ during which electromagnetic radiation is emitted by a selected one of the emitters;
wherein the duration of the second time period t₂ is set such that the electromagnetic radiation that is disregarded includes at least some electromagnetic radiation emitted by the selected emitter which is incident on the receivers and which has not passed through an object to be imaged;
wherein the duration of the first time period t₁ is 5 ns or less, 2 ns or less, or 1 ns or less;
wherein the duration of the second time period t₂ is set to be 1 ns or more, 2 ns or more, 5 ns or more, or 10 ns or more;
wherein the tomography apparatus is configured so that electromagnetic radiation that is incident on the receivers during a third time period t₃ subsequent to the second time period t₂ is used for the production of said image data when the apparatus is in use, the durations of the first, second and third time periods t₁,t₂,t₃ being set such that the electromagnetic radiation that is used for the production of image data includes at least some of the electromagnetic radiation emitted by the selected emitter which is incident on the receivers and which has passed through the object to be imaged;
wherein the tomography apparatus includes a plurality of waveguide antennae which each act as a respective one of the emitters and/or receivers and the real component μᵣ′ of the complex relative permeability μᵣ of each waveguide antenna is substantially more than 1;
wherein the apparatus includes an imaging chamber having one or more walls which define a boundary of the imaging domain, said one or more walls of the imaging chamber being lined by a lining for reducing the amount of electromagnetic radiation which reflects from the walls and onto the receivers when the apparatus is in use; and
wherein the apparatus is configured to use a computer program that produces the image data by calculating electromagnetic fields between individual pairs of emitters and receivers.
